(19) United States
(12) Patent Application Publication
(10) Pub. No.: US 2026/0142417 A1
(43) Pub. Date: May 21, 2026

(54) ELECTRICAL CONNECTOR AND CONNECTOR ASSEMBLY WITH CABLE EXTENDING OPPOSITE TO MATING DIRECTION

(71) Applicant: DONGGUAN XUNTAO ELECTRONIC CO., LTD., Dongguan City (CN)

(72) Inventors: Hengshan CHENG, Dongguan City (CN); Huanhuan SHEN, Dongguan City (CN); Jianhao LI, Dongguan City (CN)

(73) Assignee: DONGGUAN XUNTAO ELECTRONIC CO., LTD., Dongguan City (CN)

(21) Appl. No.: 19/403,697

(22) Filed: Nov. 28, 2025

Related U.S. Application Data
(63) Continuation-in-part of application No. 19/341,840, filed on Sep. 26, 2025.
Application No. 19/341,840 is a continuation of application No. 17/958,829, filed on Oct. 3, 2022, now Pat. No. 12,451,653.

(30) Foreign Application Priority Data
Oct. 12, 2021 (CN) 202122460467.2
Nov. 3, 2025 (CN) 202522333929.2

(51) Int. Cl. H01R 13/633; H01R 12/71; H01R 13/516; H01R 13/639

(52) U.S. Cl. CPC H01R 13/6335; H01R 12/716; H01R 13/516; H01R 13/639

(57) ABSTRACT

An electrical connector includes a body, a first terminal module, and a movable component. The first terminal module includes a number of first conductive terminals and a first cable. The movable component is installed on the body and movable relative to the body along a moving direction. The movable component includes a base portion, a first push rod, and a second push rod. The base portion is provided with a number of first locking protrusions. Each of one end of the first push rod and one end of the second push rod is provided with a second locking protrusion. The first locking protrusions and the second locking protrusions are configured to lock with a mating connector. A connector assembly having the electrical connector is also disclosed.

### CROSS-REFERENCE TO RELATED APPLICATIONS

This patent application is a continuation-in-part of U.S. application Ser. No. 19/341,840, filed on Sep. 26, 2025 and titled “PULL STRAP CONNECTOR AND ASSEMBLY THEREOF WITH IMPROVED LOCKING FEATURES”, which is a continuation of U.S. patent application Ser. No. 17/958,829, filed on Oct. 3, 2022 and titled “PULL STRAP CONNECTOR AND ASSEMBLY THEREOF WITH IMPROVED LOCKING FEATURES”. The present patent application also claims priority of a Chinese Patent Application No. 202522333929.2, filed on Nov. 3, 2025 and titled “ELECTRICAL CONNECTOR AND CONNECTOR ASSEMBLY”. The entire contents of the aforementioned applications are incorporated herein by reference in their entirety.

### TECHNICAL FIELD

The present disclosure relates to an electrical connector and a connector assembly, which belongs to the field of connector technology.

### BACKGROUND

A connector assembly in related technologies typically includes an electrical connector and a mating connector. The electrical connector includes an insulating body, a plurality of conductive terminals, a cable electrically connected to the conductive terminals, a locking tab located on one side of the insulating body, and a pull strap connected to the locking tab. The locking tab is provided with a hook on one side of the insulating body. The mating connector defines a locking slot that engages with the hook. An extending direction of the cable is perpendicular to a mating direction of the electrical connector and the mating connector.

However, there is still room for improvement in connector assemblies of related technologies.

### SUMMARY

An embodiment of the present disclosure adopts the following technical solution: an electrical connector including: a body, the body defining a first receiving groove and a second receiving groove; a first terminal module, the first terminal module being at least partially disposed in the body, the first terminal module including a plurality of first conductive terminals and a first cable electrically connected to the first conductive terminals; and a movable component, the movable component being mounted to the body and being movable relative to the body along a moving direction; the movable component including a base portion, a first push rod and a second push rod; the base portion being provided with a plurality of first locking protrusions; a portion of the first push rod being received in the first receiving groove, and one end of the first push rod extending out of the first receiving groove; a portion of the second push rod being received in the second receiving groove, and one end of the second push rod extending out of the second receiving groove; each of the one end of the first push rod and the one end of the second push rod being both provided with a second locking protrusion; the first locking protrusions and the second locking protrusions being configured to lock with a mating connector; wherein the first cable extends beyond the body, and the first cable extends from the body in a direction opposite to the mating direction.

An embodiment of the present disclosure adopts the following technical solution: a connector assembly including: an electrical connector, the electrical connector including: a body, the body defining a first receiving groove and a second receiving groove; a first terminal module, the first terminal module being at least partially disposed in the body, the first terminal module including a plurality of first conductive terminals and a first cable electrically connected to the first conductive terminals; and a movable component, the movable component being mounted to the body and being movable relative to the body along a moving direction; the movable component including a base portion, a first push rod and a second push rod; the base portion being provided with a plurality of first locking protrusions; a portion of the first push rod being received in the first receiving groove, and one end of the first push rod extending out of the first receiving groove; a portion of the second push rod being received in the second receiving groove, and one end of the second push rod extending out of the second receiving groove; each of the one end of the first push rod and the one end of the second push rod being both provided with a second locking protrusion; the first locking protrusions and the second locking protrusions being configured to lock with a mating connector; wherein the first cable extends beyond the body, and the first cable extends from the body in a direction opposite to the mating direction; and a mating connector, the mating connector including: a mating insulating body, the mating insulating body including a plurality of wall portions and a mating slot defined by the plurality of wall portions; the plurality of wall portions including a first wall portion, a second wall portion disposed opposite to the first wall portion, a first connecting wall portion connecting one side of the first wall portion and one side of the second wall portion, and a second connecting wall portion connecting another side of the first wall portion and another side of the second wall portion; the mating slot being configured to at least partially receive the electrical connector along a mating direction; a plurality of mating terminals, the mating terminals being at least partially disposed in the mating insulating body; each mating terminal including an elastic mating arm extending into the mating slot and configured to be in contact with the first contact surface of the first conductive terminal of the electrical connector; and a metal shell, the metal shell at least partially covering the mating insulating body; the metal shell including a first side wall, a second side wall disposed opposite to the first side wall, a first connecting wall connecting one side of the first side wall and one side of the second side wall, and a second connecting wall connecting another side of the first side wall and another side of the second side wall.

### BRIEF DESCRIPTION OF DRAWINGS

FIG. 1 is a perspective schematic view of a connector assembly in accordance with a first embodiment of the present disclosure, wherein an electrical connector is mated with a mating connector;

FIG. 2 is a perspective schematic view of FIG. 1 from another angle;

FIG. 3 is a partial exploded perspective view of FIG. 1, wherein the electrical connector and the mating connector are separated from each other;

FIG. 4 is a partial exploded perspective view of FIG. 3 from another angle;

FIG. 5 is a left-side view of the electrical connector in FIG. 3;

FIG. 6 is a right-side view of the electrical connector in FIG. 3;

FIG. 7 is an exploded perspective view of the mating connector in FIG. 3;

FIG. 8 is an exploded perspective view of FIG. 7 from another angle;

FIG. 9 is a partial exploded perspective view of the electrical connector in FIG. 3;

FIG. 10 is a partial exploded perspective view of FIG. 9 from another angle;

FIG. 11 is a further exploded perspective view of FIG. 9;

FIG. 12 is an exploded perspective view of FIG. 11 from another angle;

FIG. 13 is a perspective schematic view of a body in FIG. 11;

FIG. 14 is a perspective schematic view of FIG. 13 from another angle;

FIG. 15 is a top view of the body in FIG. 13;

FIG. 16 is a bottom view of the body in FIG. 13;

FIG. 17 is a partial exploded perspective view of a first terminal module, a second terminal module and a limiting block in FIG. 11;

FIG. 18 is a partial exploded perspective view of FIG. 17 from another angle;

FIG. 19 is a left-side view of the first terminal module in FIG. 17;

FIG. 20 is a left-side view of the second terminal module in FIG. 17;

FIG. 21 is a right-side view of the first terminal module in FIG. 17;

FIG. 22 is a right-side view of the second terminal module in FIG. 17;

FIG. 23 is an exploded perspective view of the first terminal module in FIG. 17;

FIG. 24 is an exploded perspective view of the second terminal module in FIG. 17;

FIG. 25 is a perspective schematic view of a first cable, a first shielding plate and a plurality of first conductive terminals in FIG. 23;

FIG. 26 is a perspective schematic view of a second cable, a second shielding plate and a plurality of second conductive terminals in FIG. 24;

FIG. 27 is an exploded perspective view of FIG. 25 from another angle;

FIG. 28 is an exploded perspective view of FIG. 26 from another angle;

FIG. 29 is a left-side view of FIG. 25;

FIG. 30 is a left-side view of FIG. 26;

FIG. 31 is a cross-sectional schematic view taken along line D-D in FIG. 5;

FIG. 32 is a partial enlarged view of framed portion E in FIG. 31;

FIG. 33 is a partial enlarged view corresponding to a first contact portion of the first conductive terminal and a second contact portion of the second conductive terminal in FIG. 32;

FIG. 34 is a cross-sectional schematic view taken along line F-F in FIG. 5;

FIG. 35 is a cross-sectional schematic view taken along line H-H in FIG. 5;

FIG. 36 is a partial perspective schematic view after removing the limiting block, a first insulating fixing block and a second insulating fixing block in FIG. 17;

FIG. 37 is a partial perspective schematic view of FIG. 36 from another angle;

FIG. 38 is a perspective schematic view of a first terminal assembly composed of a plurality of first ground terminals, a plurality of second ground terminals, and a first carrier strip portion; a second terminal assembly composed of a plurality of first signal terminals, a plurality of second signal terminals, and a second carrier strip portion; a third terminal assembly composed of a plurality of third ground terminals, a plurality of fourth ground terminals, and a third carrier strip portion; and a fourth terminal assembly composed of a plurality of third signal terminals, a plurality of fourth signal terminals, and a fourth carrier strip portion;

FIG. 39 is a perspective schematic view of the first terminal assembly and the second terminal assembly which are assembled together, and the third terminal assembly and the fourth terminal assembly which are assembled together; and

FIG. 40 is a perspective schematic view after injection molding a first insulating block and a second insulating block based on FIG. 39.

It is understandable to those skilled in the art that the drawings provided herein are for the purpose of illustrating specific embodiments of the present disclosure, and the proportions shown in the drawings are merely illustrative of these embodiments; other embodiments may not necessarily be implemented to scale.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

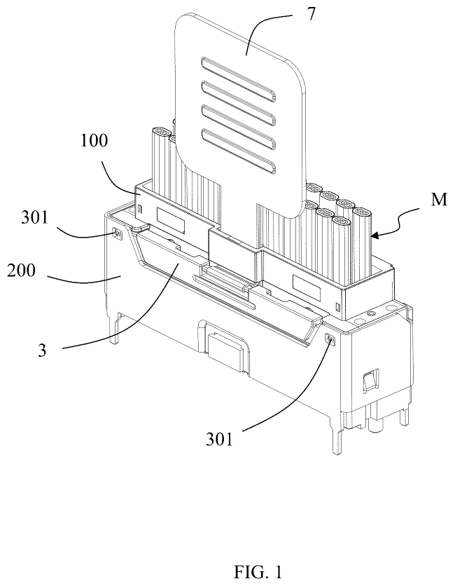

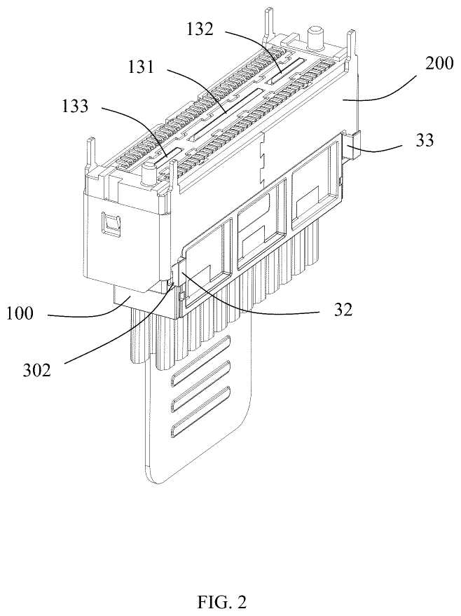

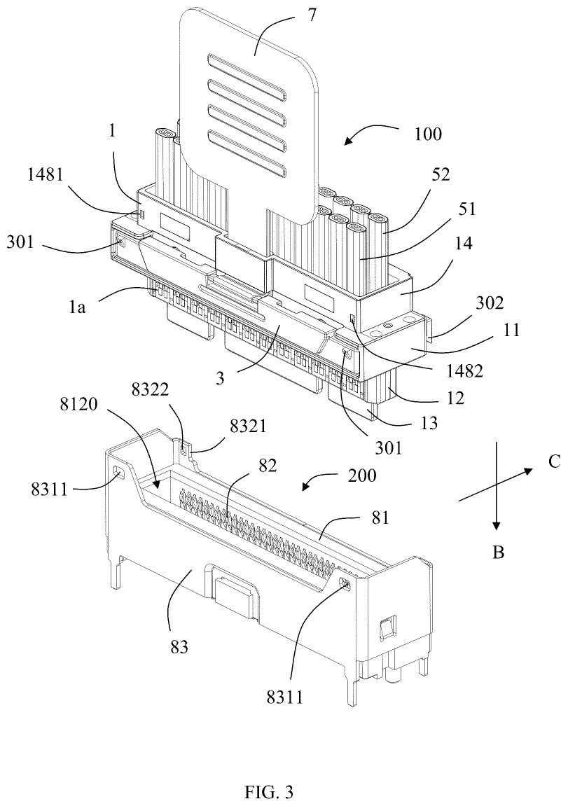

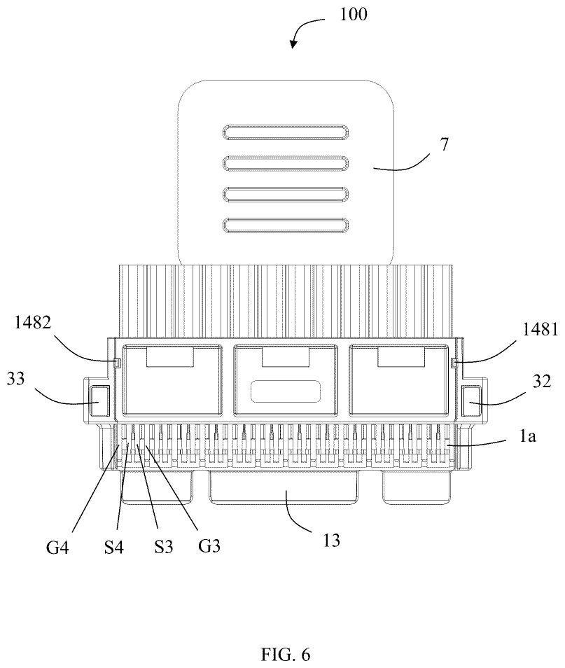

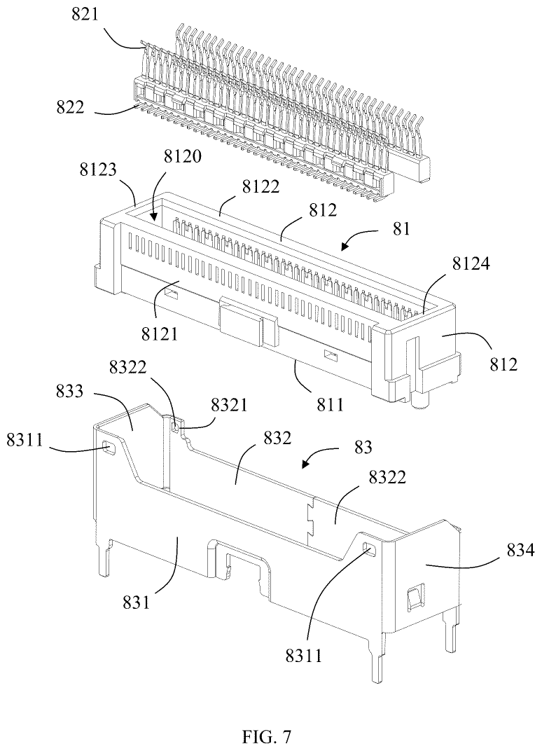

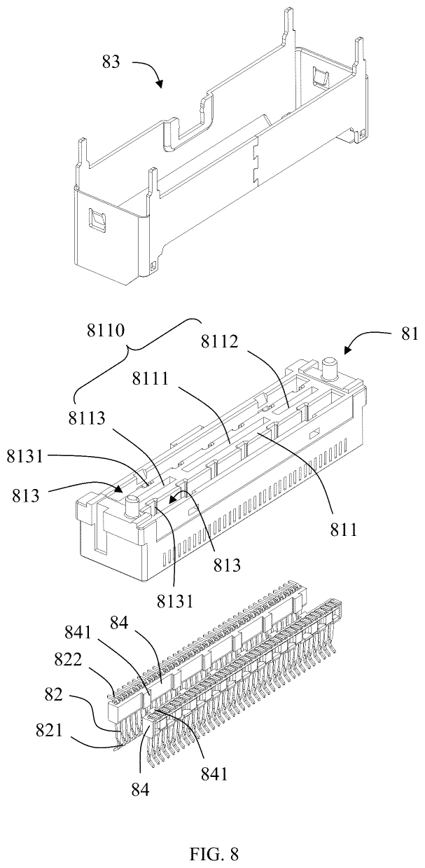

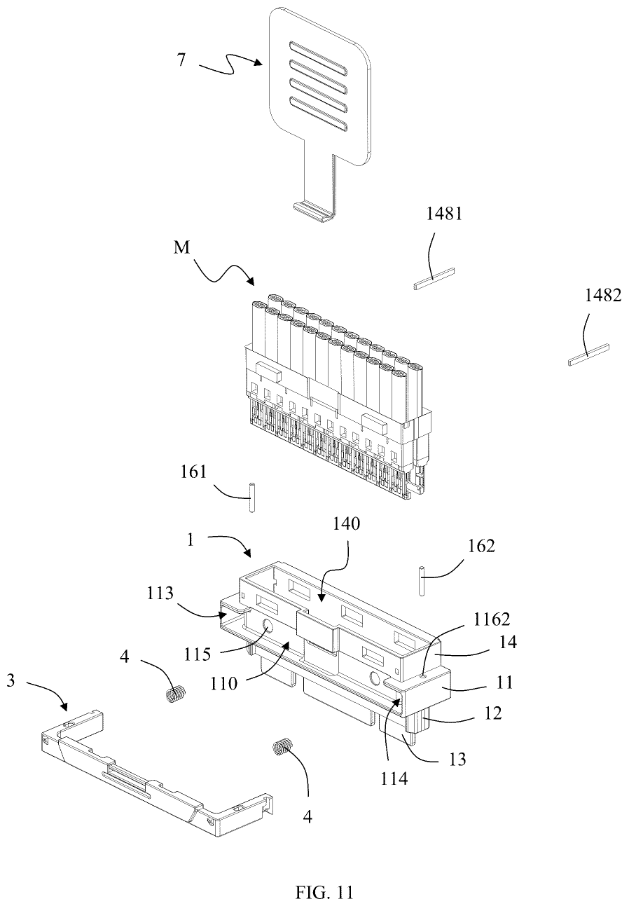

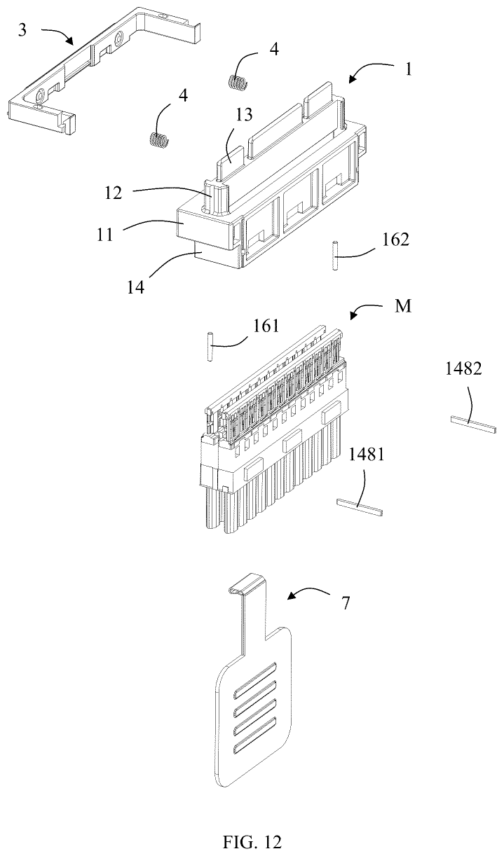

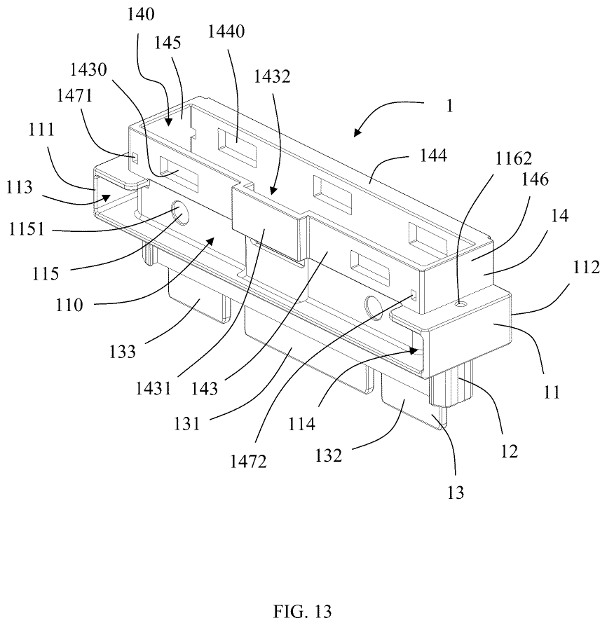

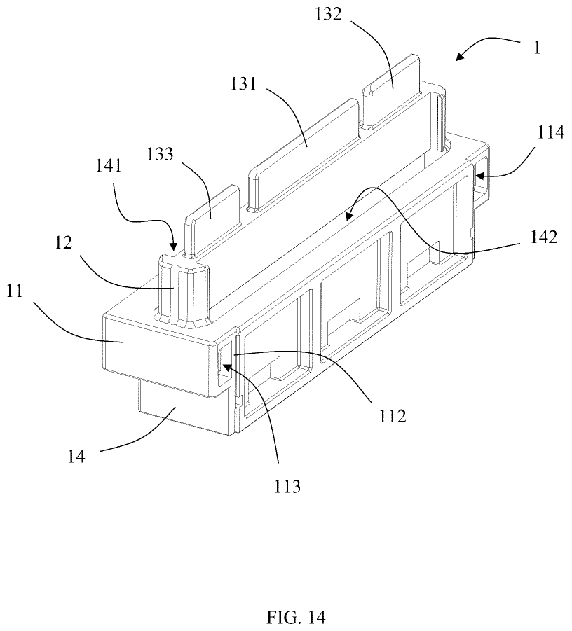

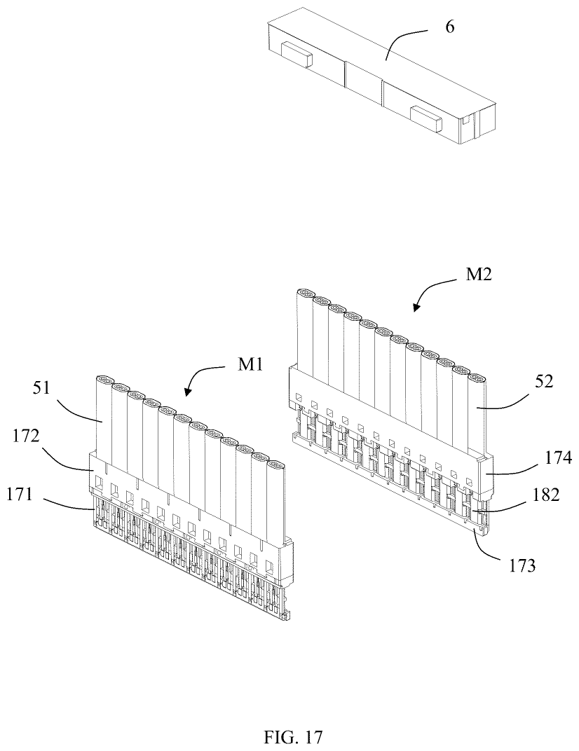

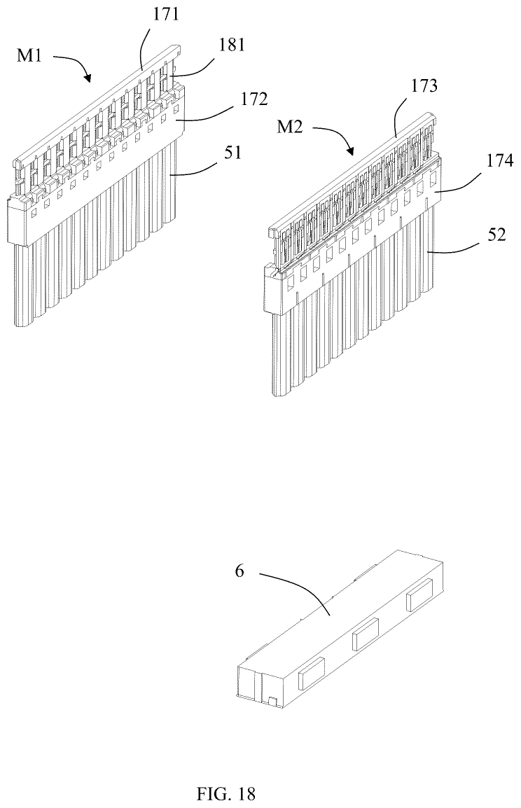

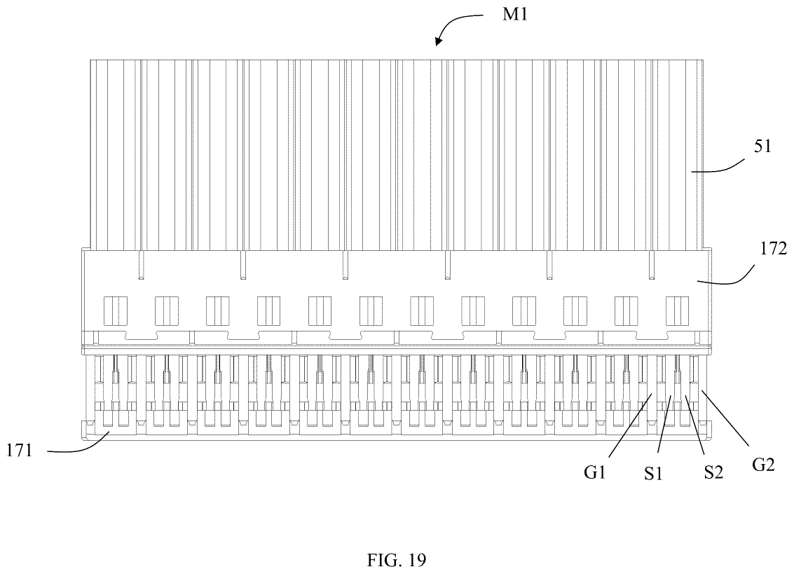

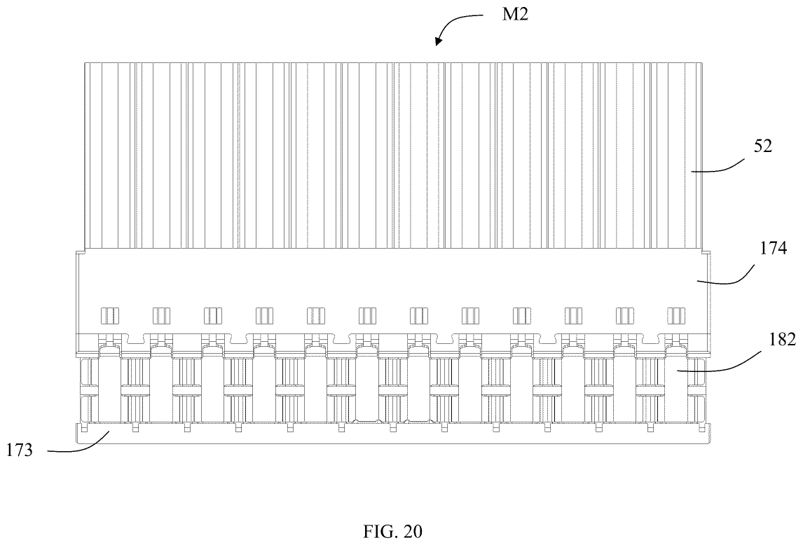

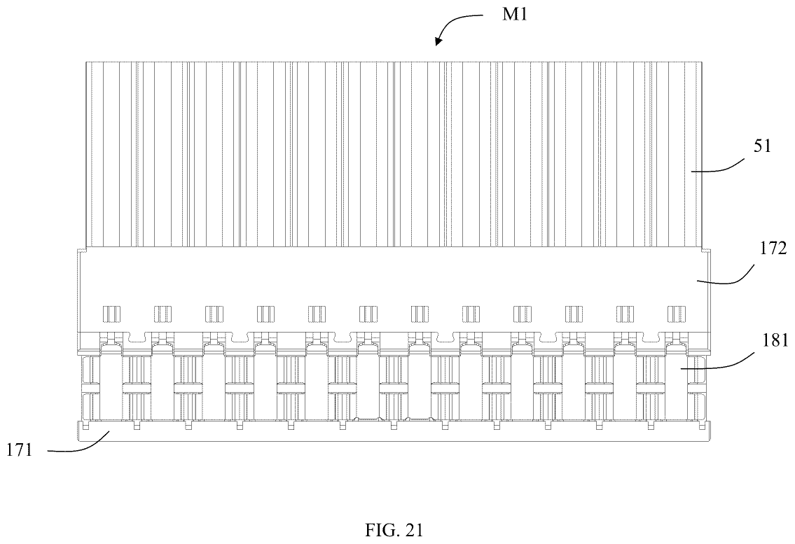

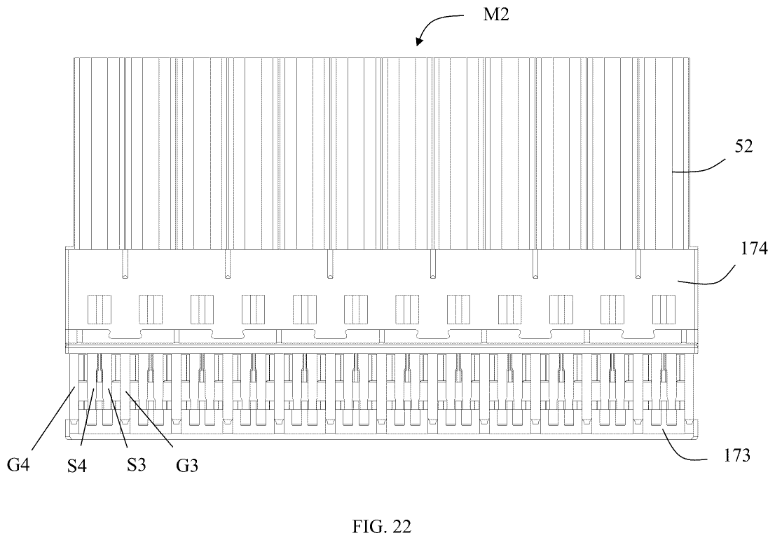

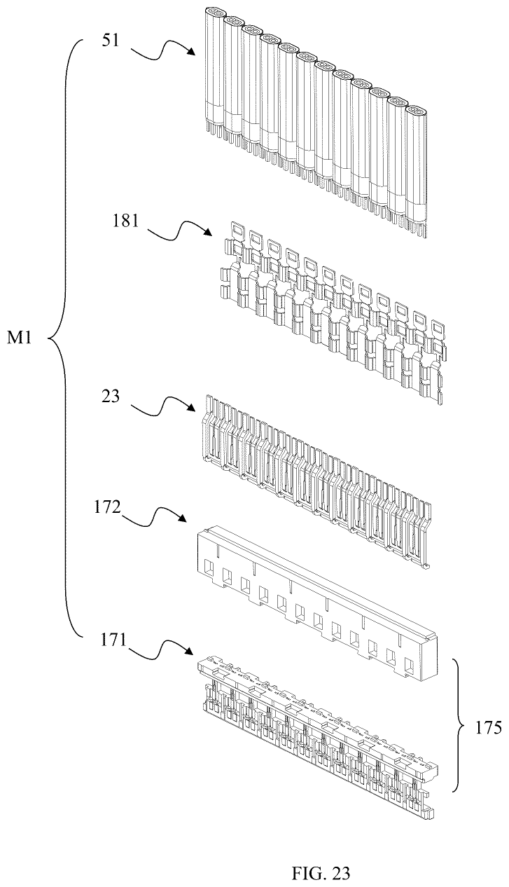

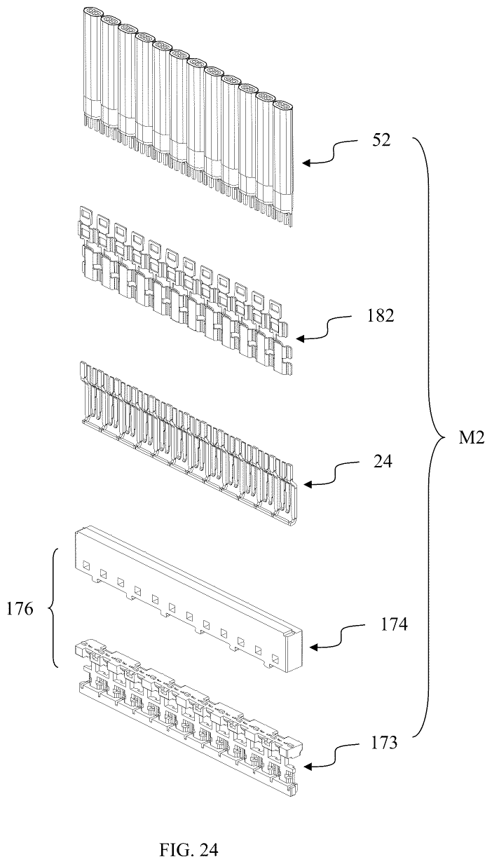

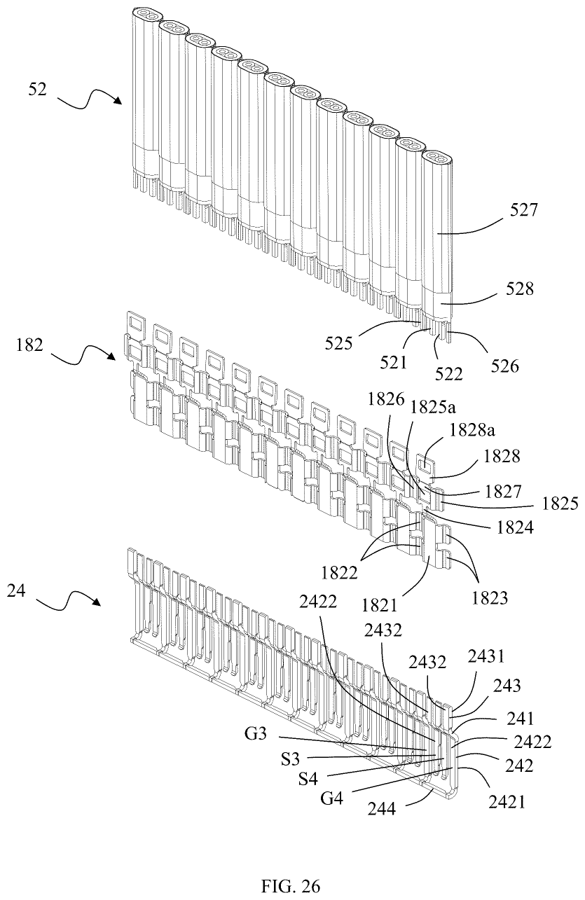

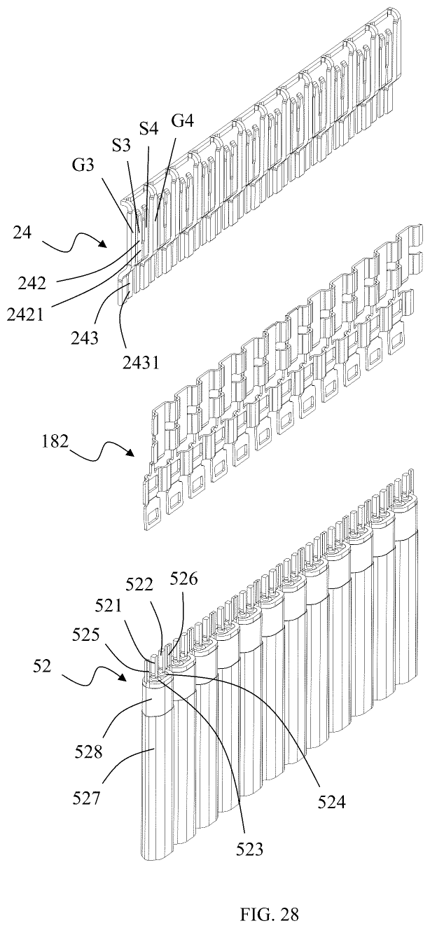

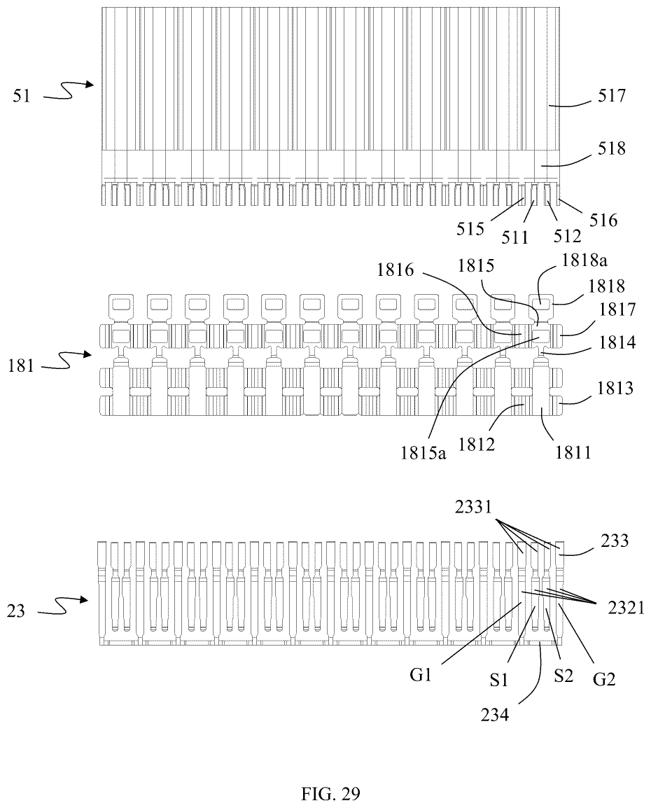

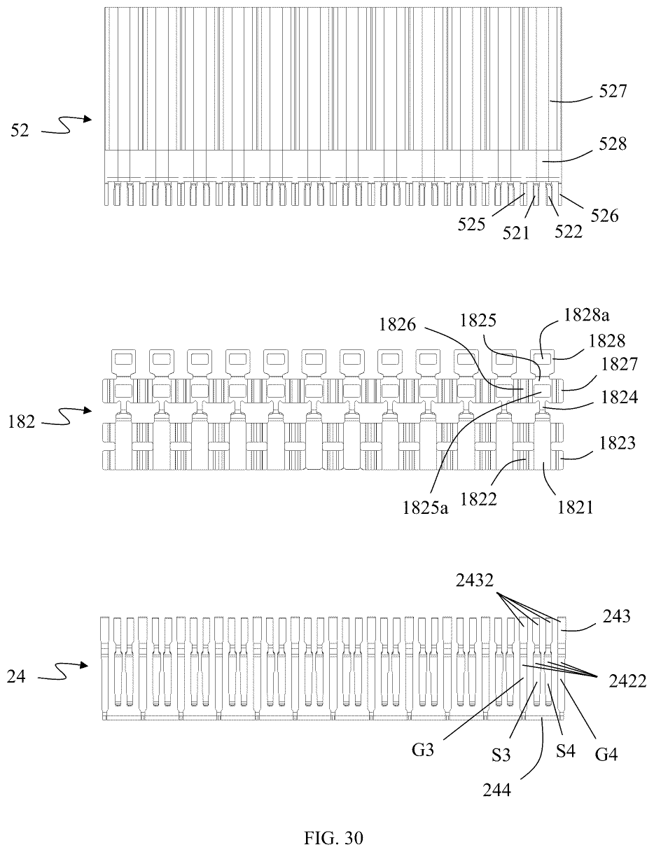

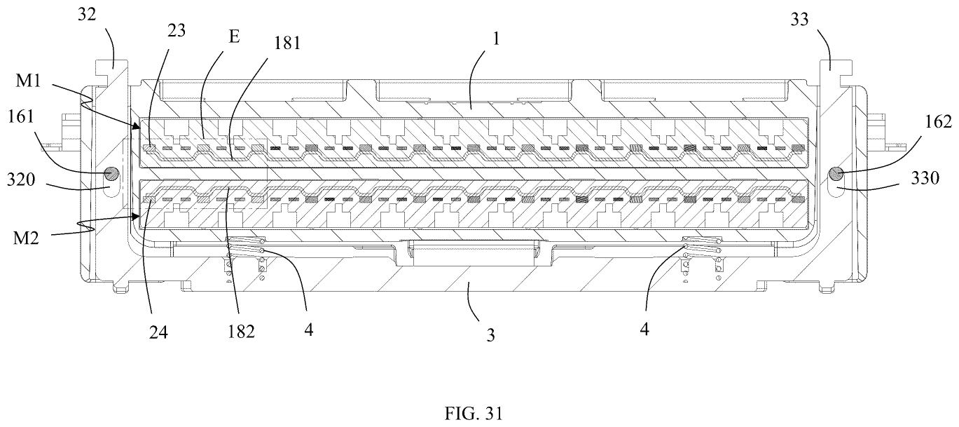

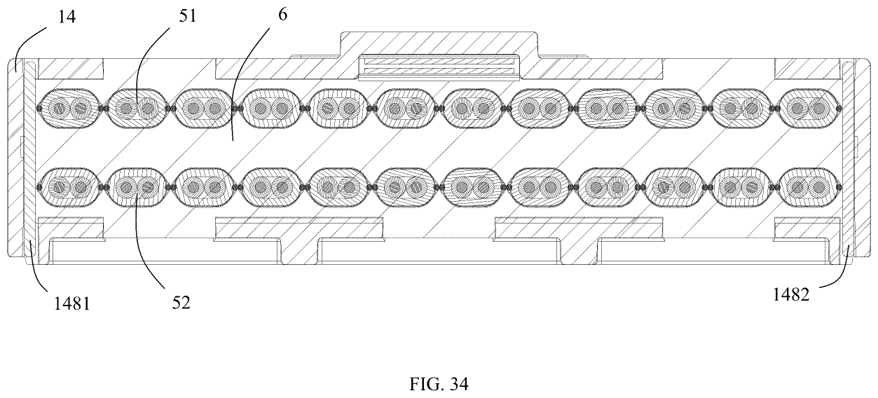

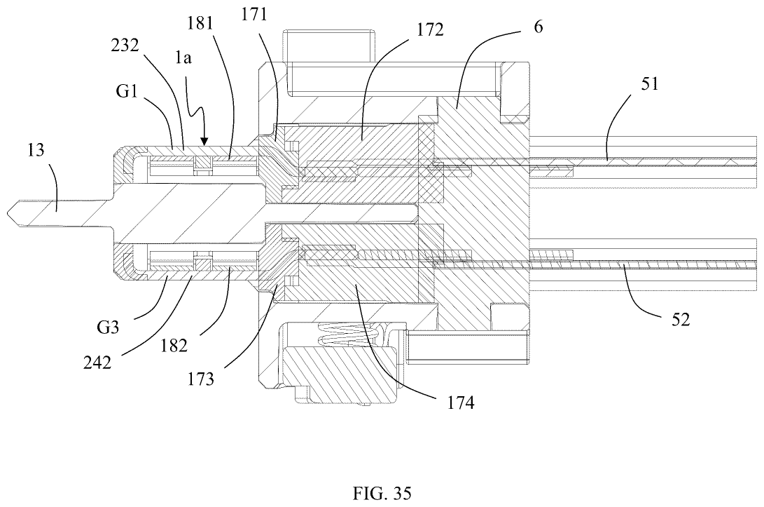

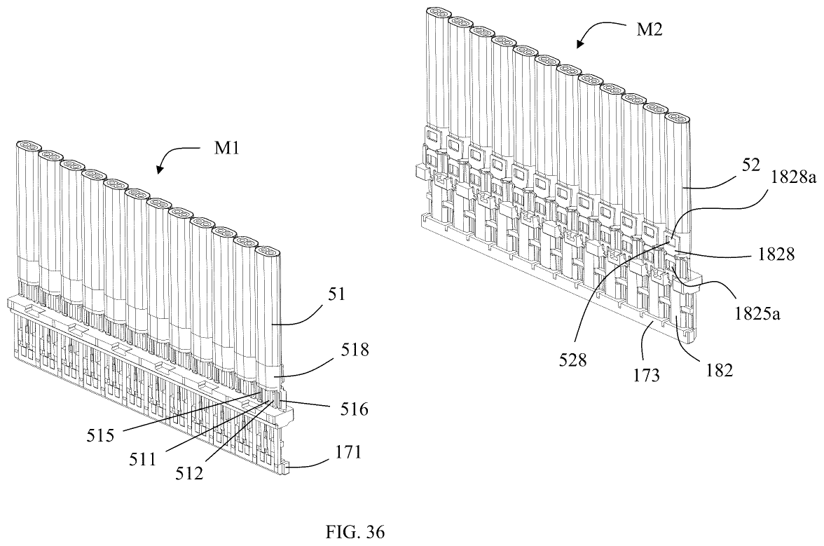

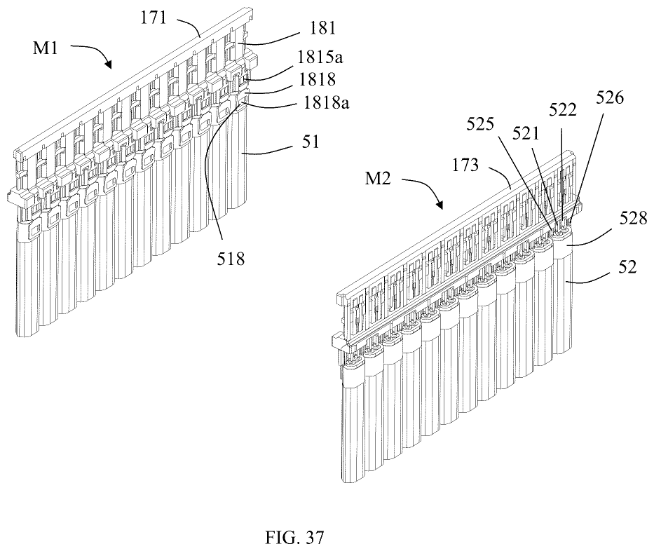

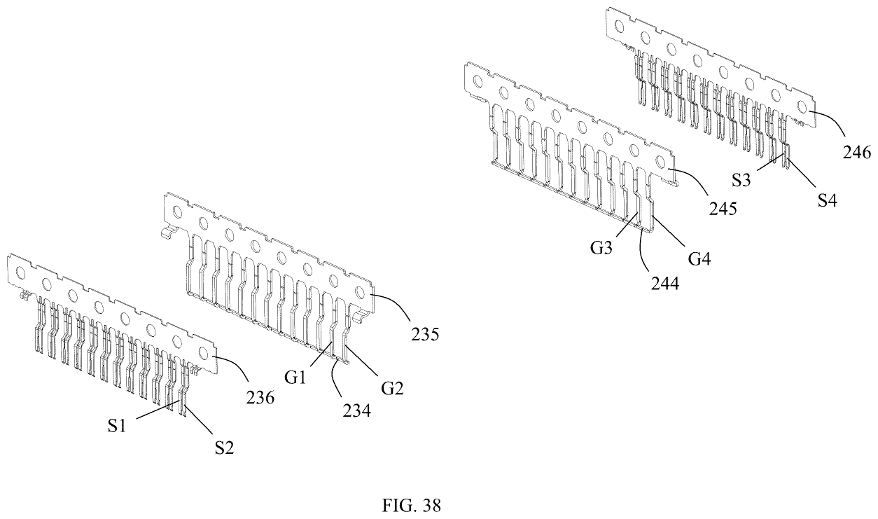

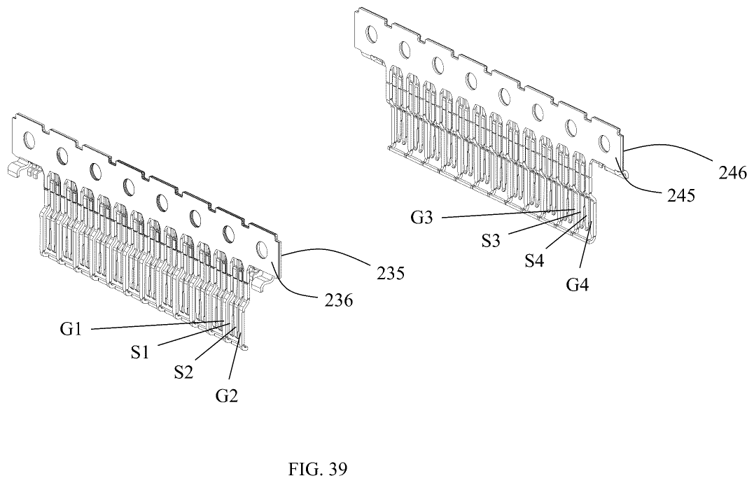

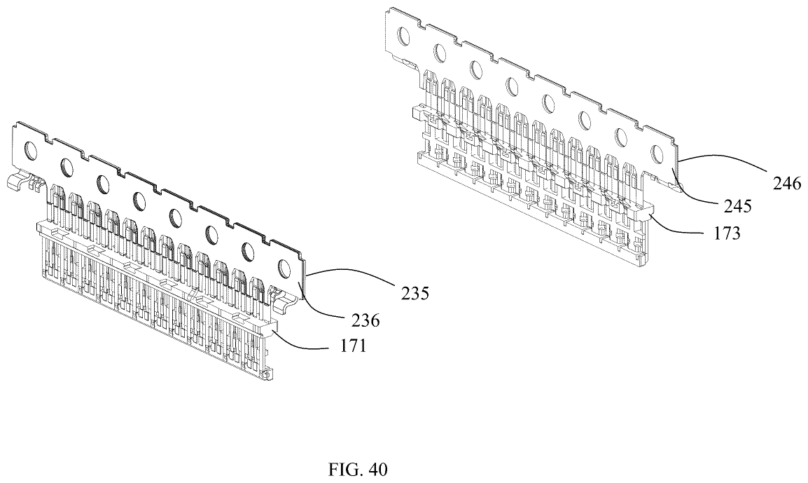

Referring to FIG. 1 to FIG. 40, the present disclosure discloses a connector assembly, which includes an electrical connector 100 and a mating connector 200 for mating with the electrical connector 100. In the illustrated embodiment of the present disclosure, the electrical connector 100 is a pull strap connector and a cable end connector. The mating connector 200 is a board-end connector and configured to be mounted on a circuit board (not shown). Referring to FIG. 3, the electrical connector 100 is configured to mate with the mating connector 200 along a mating direction B (for example, a top-to-bottom direction) to realize data and/or power transmission.

Referring to FIG. 3 to FIG. 6 and FIG. 9 to FIG. 27, in the illustrated embodiment of the present disclosure, the electrical connector 100 is a vertical connector. The electrical connector 100 includes a body 1, a terminal module M at least partially disposed in the body 1, a movable component 3 mounted to the body 1, an elastic component 4 configured to abut against the movable component 3, a limiting block 6 fixed to the body 1 and at least partially abutting against the terminal module M, and a pull strap 7 connected to the movable component 3. The pull strap 7 is configured to drive the movable component 3 to overcome the force of the elastic component 4, causing the movable component 3 to move along a movement direction C (for example, a front-rear direction) perpendicular to the mating direction B. In the illustrated embodiments of the present disclosure, an extending direction of the pull strap 7 is opposite to the mating direction B.

In one embodiment of the present disclosure, the body 1 is a metal body, meaning it is made of a metal material. This configuration allows the body 1 to provide effective shielding and helps enhance the structural strength of the electrical connector 100. In the illustrated embodiment of the present disclosure, the body 1 includes a main body portion 11, an extension plate 12 protruding downwardly from the main body portion 11 along the mating direction B, a positioning plate 13 further protruding downwardly from the extension plate 12 along the mating direction B, and a mounting portion 14 protruding upwardly from the main body portion 11 in a direction opposite to the mating direction B. In the illustrated embodiment of the present disclosure, the main body portion 11, the extension plate 12, the positioning plate 13 and the mounting portion 14 are integrally formed. In the illustrated embodiment of the present disclosure, a dimension of the main body portion 11 in a front-rear direction/a second direction, a dimension of the extension plate 12 in the front-rear direction, and a dimension of the positioning plate 13 in the front-rear direction become smaller in sequence, so that the main body portion 11, the extension plate 12 and the positioning plate 13 are roughly of a stepped configuration as a whole. The positioning plate 13 includes a first positioning piece 131 located in a middle, a second positioning piece 132 located on one side of the first positioning piece 131, and a third positioning piece 133 located on another side of the first positioning piece 131. The second positioning piece 132 is spaced apart from the first positioning piece 131. The third positioning piece 133 is spaced apart from the first positioning piece 131. A dimension of the first positioning piece 131 along a left-right direction/a first direction is larger than a dimension of the second positioning piece 132 along the left-right direction. The dimension of the first positioning piece 131 along the left-right direction is also larger than a dimension of the third positioning piece 133 along the left-right direction. It is known that, the left-right direction is perpendicular to both the top-bottom direction and the front-rear direction. In the illustrated embodiment of the present disclosure, a distance between the first positioning piece 131 and the second positioning piece 132 is different from a distance between the first positioning piece 131 and the third positioning piece 133. This arrangement prevents the electrical connector 100 from being inserted into the mating connector 200 at a wrong angle, so that a certain foolproof effect can be achieved. In the illustrated embodiment of the present disclosure, the positioning plate 13 is made of a metal material, which facilitates the elimination of static electricity through the positioning plate 13 during the initial contact between the electrical connector 100 and the mating connector 200, as well as enhances structural strength.

The main body portion 11 includes a first end wall 111 (for example, a front end wall) and a second end wall 112 (for example, a rear end wall) opposite to the first end wall 111. The main body portion 11 further includes a receiving space 110 extending forwardly through the first end wall 111, a first receiving groove 113 located on one side (for example, a left side) of the receiving space 110, and a second receiving groove 114 located on another side (for example, a right side) of the receiving space 110. The receiving space 110 does not extend backwardly through the second end wall 112. The main body portion 11 includes an inner wall surface 115 exposed to the receiving space 110. In the illustrated embodiment of the present disclosure, the main body portion 11 defines a receiving hole 1151 formed on the inner wall surface 115, and the receiving hole 1151 is configured to position the elastic component 4. One end of the elastic component 4 is disposed in the receiving hole 1151, and another end of the elastic component 4 abuts against the movable component 3. The first receiving groove 113 and the second receiving groove 114 extend through the second end wall 112 along the moving direction C.

Besides, the main body portion 11 further includes a top surface 116, a first mounting hole 1161 that extends upwardly through the top surface 116 and is located on one side (for example, a left side) of the main body portion 11, and a second mounting hole 1162 that extends upwardly through the top surface 116 and is located on another side (for example, a right side) of the main body portion 11. The first mounting hole 1161 extends along the mating direction B and is in communication with the first receiving slot 113. The second mounting hole 1162 extends along the mating direction B and is in communication with the second receiving slot 114.

In the illustrated embodiment of the present disclosure, the mounting portion 14 includes a mounting space 140 extending upwardly through the mounting portion 14, a first mounting groove 141 that communicates with the mounting space 140, and extends downwardly through the main body portion 11 and the extension plate 12, and a second mounting groove 142 that communicates with the mounting space 140, and extends downwardly through the main body portion 11 and the extension plate 12. The first mounting groove 141 and the second mounting groove 142 are located on opposite sides (for example, front and rear sides) of the extension plate 12, respectively.

In the illustrated embodiment of the present disclosure, the mounting portion 14 is frame-shaped, and includes a first mounting wall 143 (for example, a front mounting wall), a second mounting wall 144 (for example, a rear mounting wall) disposed opposite to the first mounting wall 143, a third mounting wall 145 connecting one side of the first mounting wall 143 and one side of the second mounting wall 144, and a fourth mounting wall 146 connecting another side of the first mounting wall 143 and another side of the second mounting wall 144. The mounting space 140 is enclosed by the first mounting wall 143, the second mounting wall 144, the third mounting wall 145 and the fourth mounting wall 146.

In the illustrated embodiment of the present disclosure, the first mounting wall 143 is provided with a protruding portion 1431 which extends forwardly, and a mounting groove 1432 which is located at a rear end of the protruding portion 1431 and corresponds to the protruding portion 1431. The mounting groove 1432 communicates rearward with the mounting space 140 and downward with the receiving space 110. The mounting groove 1432 is configured to allow the pull strap 7 to pass through, enabling the pull strap 7 to connect with the movable component 3. Besides, the first mounting wall 143 further includes a plurality of first perforations 1430 that extend through the first mounting wall 143 in the front-rear direction. The second mounting wall 144 further includes a plurality of second perforations 1440 that extend through the second mounting wall 144 in the front-rear direction. The mounting portion 14 further defines a first positioning hole 1471 and a second positioning hole 1472, both extending in the front-rear direction. In the illustrated embodiment of the present disclosure, the first positioning hole 1471 extends through both the first mounting wall 143 and the second mounting wall 144, and is located on one side of the mounting portion 14. The second positioning hole 1472 extends through both the first mounting wall 143 and the second mounting wall 144, and is located on another side of the mounting portion 14. The first positioning hole 1471 and the second positioning hole 1472 are configured to accommodate a first stop bar 1481 and a second stop bar 1482, respectively, to restrict the movement of the terminal module M.

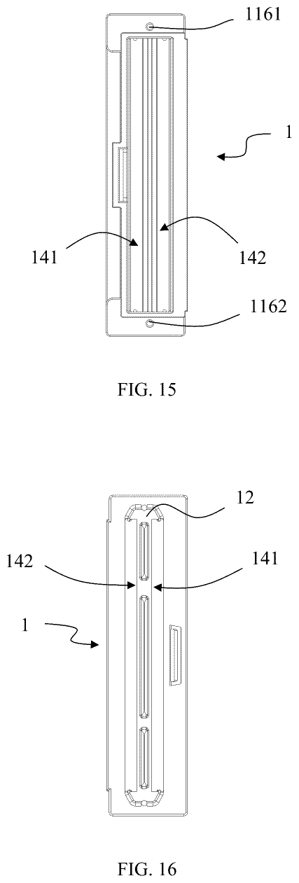

Referring FIG. 15 to FIG. 33, in the illustrated embodiment of the present disclosure, the terminal module M includes a first terminal module M1 and a second terminal module M2. The first terminal module M1 includes a first insulating block 171, a plurality of first conductive terminals 23 fixed to the first insulating block 171, a plurality of first cables 51 connected to the plurality of first conductive terminals 23, a first shielding plate 181 coupled to the first insulating block 171, and a first insulating fixing block 172 at least partially fixed to the first insulating block 171, the first conductive terminals 23, the first cables 51 and the first shielding plate 181. In the illustrated embodiments of the present disclosure, the first conductive terminals 23 are insert-molded with the first insulating block 171. The first insulating fixing block 172 is secondarily molded onto the first insulating block 171, the first conductive terminals 23, the first cables 51, and the first shielding plate 181 to form the first terminal module M1 as an integrated unit. In other embodiments of the present disclosure, the first insulating block 171 and the first insulating fixing block 172 may also be integrally formed, meaning the first insulating block 171 and the first insulating fixing block 172 are a single component, collectively referred to as a first insulating molding block 175. Of course, it is understandable to those skilled in the art that in other embodiments, the first conductive terminals 23 may also be fixed to the first insulating block 171 by assembly.

The plurality of first conductive terminals 23 include a first ground terminal G1, a second ground terminal G2, a first signal terminal S1, and a second signal terminal S2. The first signal terminal S1 and the second signal terminal S2 form a first differential pair to enhance the speed of signal transmission. The first ground terminal G1 and the second ground terminal G2 are located on two sides (for example, left and right sides) of the first differential pair, respectively, to improve the ground shielding effectiveness and enhance the quality of signal transmission.

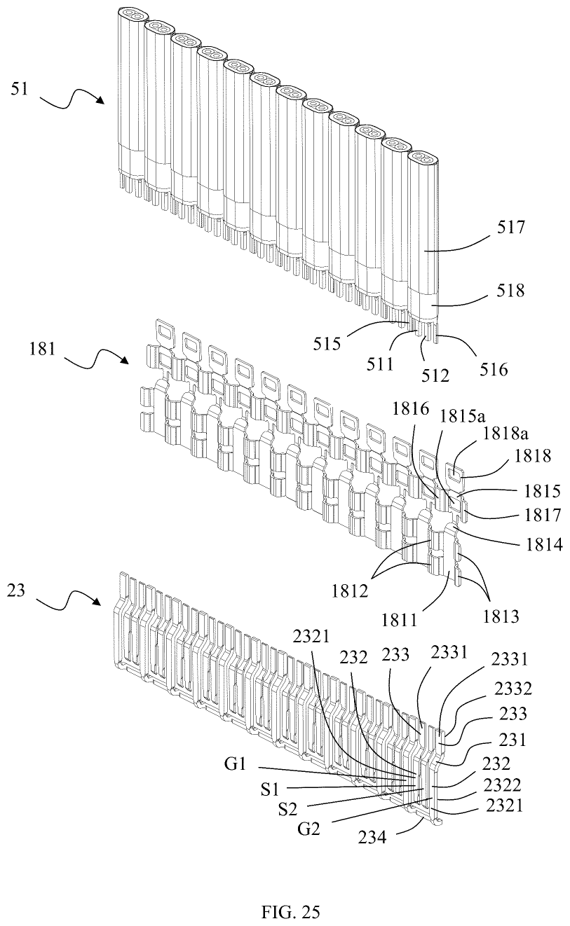

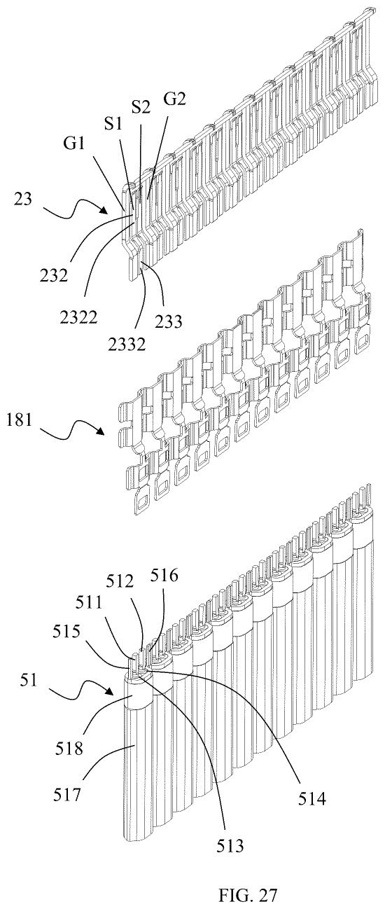

Referring to FIG. 25 and FIG. 27, in the illustrated embodiment of the present disclosure, each first conductive terminal 23 includes a first fixing portion 231 fixed in the first insulating block 171, a first contact portion 232 extending from one end of the first fixing portion 231, and a first tail portion 233 extending from another end of the first fixing portion 231. The first contact portion 232 includes a first contact surface 2321 exposed from the first insulating block 171, and a first back surface 2322 disposed opposite to the first contact surface 2321. In the illustrated embodiment of the present disclosure, the first fixing portion 231 is arranged obliquely, positioning the first contact portion 232 and the first tail portion 233 in different planes. The first tail portion 233 includes a first soldering surface 2331 and a first abutting surface 2332 disposed opposite to the first soldering surface 2331.

In one embodiment of the present disclosure, the first conductive terminals 23 further include a first connecting rod 234 that connects a distal end of the first contact portion 232 of the first ground terminal G1 with a distal end of the first contact portion 232 of the second ground terminal G2, to achieve better signal integrity and improve ground shielding effectiveness. In the illustrated embodiment of the present disclosure, the first connecting rod 234 is embedded in the first insulating block 171 after the insert-molding process.

In one embodiment of the present disclosure, the first ground terminal G1 and the second ground terminal G2 are stamped from a first material strip. The first signal terminal S1 and the second signal terminal S2 are stamped from a second material strip. A thickness of the first material strip is greater than that of the second material strip to further enhance the ground shielding effect. The first ground terminal G1 and the second ground terminal G2 are manufactured using one set of stamping dies. The first signal terminal S1 and the second signal terminal S2 are manufactured using another set of stamping dies. These two sets of stamping dies are different. The first cable 51 includes a first core 511, a second core 512, a first insulating layer 513 wrapping around the first core 511, a second insulating layer 514 wrapping around the second core 512, a first ground wire 515 located outside the first insulating layer 513, a second ground wire 516 located outside the second insulating layer 514, a first shielding layer 518 located outside both the first insulating layer 513 and the second insulating layer 514, and an outermost first insulating sheath 517. As shown in FIG. 3, in the illustrated embodiment of the present disclosure, the first cable 51 extends from the body 1 in a direction opposite to the mating direction B, meaning that a portion of the first cable 51 just protruding out of the body 1 extends in the direction opposite to the mating direction B. It is understandable to those skilled in the art that a length of the first cable 51 may vary depending on the application, and the first cable 51 may experience local deviations, bends, etc., along its entire length. However, this does not affect the description in the present disclosure that the portion of the first cable 51 just protruding out of the body 1 extends in the direction opposite to the mating direction B. This arrangement minimizes a space occupied by the electrical connector 100 in both the front-rear direction and the left-right direction, thereby facilitating installation and layout.

In the illustrated embodiment of the present disclosure, the first core 511 and the second core 512 are in contact with (for example, soldered to) the first soldering surface 2331 of the first signal terminal S1 and the first soldering surface 2331 of the second signal terminal S2, respectively. The first ground wire 515 and the second ground wire 516 are in contact with (for example, soldered to) the first soldering surface 2331 of the first ground terminal G1 and the first soldering surface 2331 of the second ground terminal G2, respectively.

Referring to FIG. 25, the first shielding plate 181 is a first metal shielding plate, meaning it is made of a metal material. The first shielding plate 181 is generally wavy in shape, and includes a first base portion 1811, a first abutting portion 1812 bent from one side of the first base portion 1811, a second abutting portion 1813 bent from another side of the first base portion 1811, a first extension portion 1814 connected to the first base portion 1811, a second base portion 1815 connected to the first extension portion 1814, a third abutting portion 1816 bent from one side of the second base portion 1815, a fourth abutting portion 1817 bent from another side of the second base portion 1815, and a first end protrusion 1818 connected to the second base portion 1815. The first end protrusion 1818, the second base portion 1815, the first extension portion 1814 and the first base portion 1811 are connected in sequence along the mating direction B. In the illustrated embodiment of the present disclosure, an overall length of the first base portion 1811, the first extension portion 1814, and the second base portion 1815 along the mating direction B is comparable to an overall length of the first contact portion 232, the first fixing portion 231, and the first tail portion 233 of the first conductive terminal 23. With this configuration, the first shielding plate 181 is able to cover the length of the first conductive terminal 23 as much as possible, thereby improving the ground shielding effect.

In the illustrated embodiment of the present disclosure, the first base portion 1811 does not have any opening along its length in the mating direction B, thereby providing superior shielding effectiveness. The second base portion 1815 defines a first through hole 1815a in which the first tail portions 233 of both the first signal terminal S1 and the second signal terminal S2 are at least partially exposed. This arrangement facilitates soldering on one hand and, on the other hand, allows the first insulating fixing block 172 to fill the first through hole 1815a during secondary molding, thereby enhancing the reliability of the connection between the first core 511 and the first tail portion 233 of the first signal terminal S1, as well as between the second core 512 and the first tail portion 233 of the second signal terminal S2. The first end protrusion 1818 extends upwardly beyond the first tail portion 233 of the first conductive terminal 23, and defines a first solder accommodating hole 1818a. The first shielding layer 518 is exposed in the first solder accommodating hole 1818a, meaning that the first shielding layer 518 is visible when viewed from the outside into the first solder accommodating hole 1818a. This configuration facilitates filling the first solder accommodating hole 1818a with a solder to securely solder the first shielding layer 518 to the first end protrusion 1818 on one hand and, and on the other hand, allows the first insulating fixing block 172 to fill the first solder accommodating hole 1818a during secondary molding, thereby improving structural strength.

The number of the first abutting portions 1812 is one or more, and the number of the second abutting portions 1813 is one or more. In the illustrated embodiment of the present disclosure, two first abutting portions 1812 and two second abutting portions 1813 are provided to achieve multi-point contact.

Specifically, the first abutting portion 1812 is in contact with the first back surface 2322 of the first contact portion 232 of the first ground terminal G1. The second abutting portion 1813 is in contact with the first back surface 2322 of the first contact portion 232 of the second ground terminal G2. The third abutting portion 1816 is in contact with the first abutting surface 2332 of the first tail portion 233 of the first ground terminal G1. The fourth abutting portion 1817 is in contact with the first abutting surface 2332 of the first tail portion 233 of the second ground terminal G2. With this arrangement, by bringing the first shielding plate 181 into contact with the first ground terminal G1 and the second ground terminal G2, it helps improve the ground shielding effect. Of course, it is understandable to those skilled in the art that the first signal terminal S1 and the second signal terminal S2 are not in contact with the first shielding plate 181 under any circumstances to prevent short circuits.

In one embodiment of the present disclosure, the first abutting portion 1812 is fixed to the first back surface 2322 of the first contact portion 232 of the first ground terminal G1 by soldering. The second abutting portion 1813 is fixed to the first back surface 2322 of the first contact portion 232 of the second ground terminal G2 by soldering. The third abutting portion 1816 is fixed to the first abutting surface 2332 of the first tail portion 233 of the first ground terminal G1 by soldering. The fourth abutting portion 1817 is fixed to the first abutting surface 2332 of the first tail portion 233 of the second ground terminal G2 by soldering.

During manufacturing, in one embodiment of the present disclosure, the first ground terminal G1 and the second ground terminal G2 are connected to a first carrier strip portion 235. The first signal terminal S1 and the second signal terminal S2 are connected to a second carrier strip portion 236. The first carrier strip portion 235 and the second carrier strip portion 236 are then stacked together, with the first ground terminal G1, the first signal terminal S1, the second signal terminal S2, and the second ground terminal G2 arranged sequentially along the left-right direction, ensuring that the relative positions among the terminals meet the design requirements. Subsequently, the first ground terminal G1, the second ground terminal G2, the first signal terminal S1, and the second signal terminal S2 are placed into a plastic mold, and the first insulating block 171 is fixed onto the first conductive terminal 23 through injection molding. Then, the first core 511, the second core 512, the first ground wire 515 and the second ground wire 516 of the first cable 51 are soldered to the first soldering surface 2331 of the first signal terminal S1, the first soldering surface 2331 of the second signal terminal S2, the first soldering surface 2331 of the first ground terminal G1, and the first soldering surface 2331 of the second ground terminal G2, respectively. Finally, the first insulating fixing block 172 is over-molded onto the first insulating block 171, the first conductive terminal 23, the first cable 51 and the first shielding plate 181 to integrate the first terminal module M1 into a single unit.

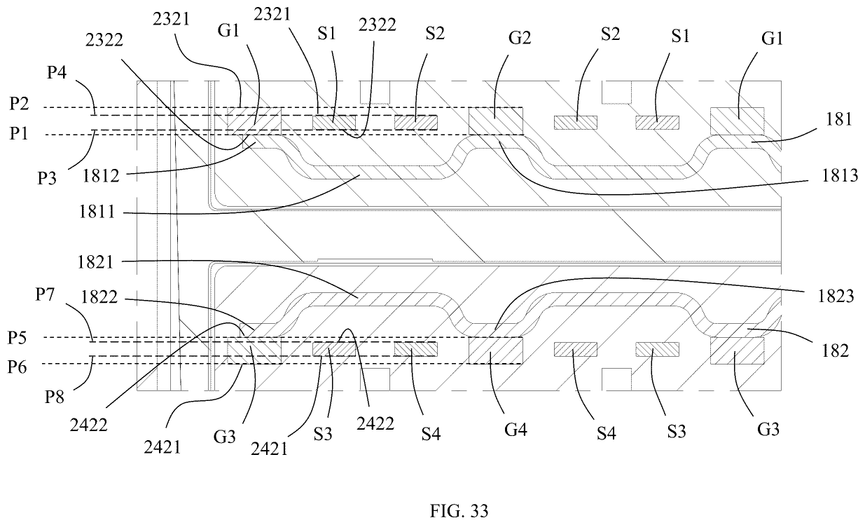

Referring to FIG. 33, in the illustrated embodiment of the present disclosure, regarding the first contact portion 232 of the first ground terminal G1, the first contact portion 232 of the first signal terminal S1, the first contact portion 232 of the second signal terminal S2, and the first contact portion 232 of the second ground terminal G2, the first back surface 2322 of the first contact portion 232 of the first ground terminal G1 is flush with the first back surface 2322 of the first contact portion 232 of the second ground terminal G2, and lies in a first plane P1. The first contact surface 2321 of the first contact portion 232 of the first ground terminal G1 is flush with the first contact surface 2321 of the first contact portion 232 of the second ground terminal G2, and lies in a second plane P2. The first back surface 2322 of the first contact portion 232 of the first signal terminal S1 is flush with the first back surface 2322 of the first contact portion 232 of the second signal terminal S2, and lies in a third plane P3. The first contact surface 2321 of the first contact portion 232 of the first signal terminal S1 is flush with the first contact surface 2321 of the first contact portion 232 of the second signal terminal S2, and lies in a fourth plane P4. In the illustrated embodiment of the present disclosure, in the front-rear direction, the first plane P1 extends rearward beyond the third plane P3, and the second plane P2 extends forward beyond the fourth plane P4. A distance between the first plane P1 and the second plane P2 is greater than a distance between the third plane P3 and the fourth plane P4. With this configuration, the first ground terminal G1 and the second ground terminal G2 can better reduce crosstalk between differential signal pairs and improve signal transmission quality.

Specifically, in one embodiment of the present disclosure, a distance between the first plane P1 and the third plane P3 is greater than 0, and less than or equal to half a distance between the first contact surface 2321 of the first contact portion 232 of the first signal terminal S1 and the first back surface 2322 of the first contact portion 232 of the first signal terminal S1 (i.e., a thickness of the first contact portion 232 of the first signal terminal S1). Similarly, a distance between the second plane P2 and the fourth plane P4 is greater than 0, and less than or equal to half the distance between the first contact surface 2321 of the first contact portion 232 of the first signal terminal S1 and the first back surface 2322 of the first contact portion 232 of the first signal terminal S1 (i.e., the thickness of the first contact portion 232 of the first signal terminal S1). In one embodiment of the present disclosure, a distance value between the second plane P2 and the third plane P3 divided by a distance value between the third plane P3 and the fourth plane P4 is R1, where 1.2≤R1≤1.4. A distance value between the first plane P1 and the fourth plane P4 divided by the distance value between the third plane P3 and the fourth plane P4 is R2, where 1.2≤R2≤1.4. A distance value between the first plane P1 and the second plane P2 divided by the distance value between the third plane P3 and the fourth plane P4 is R3, where 1.4≤R3≤1.6. In one embodiment of the present disclosure, R1=1.3, R2=1.3, and R3=1.5.

Of course, in other embodiments of the present disclosure, the first plane P1 may also be flush with the third plane P3, meaning that the first plane P1 and the third plane P3 are the same plane. Similarly, the second plane P2 may also be flush with the fourth plane P4, meaning that the second plane P2 and the fourth plane P4 are the same plane.

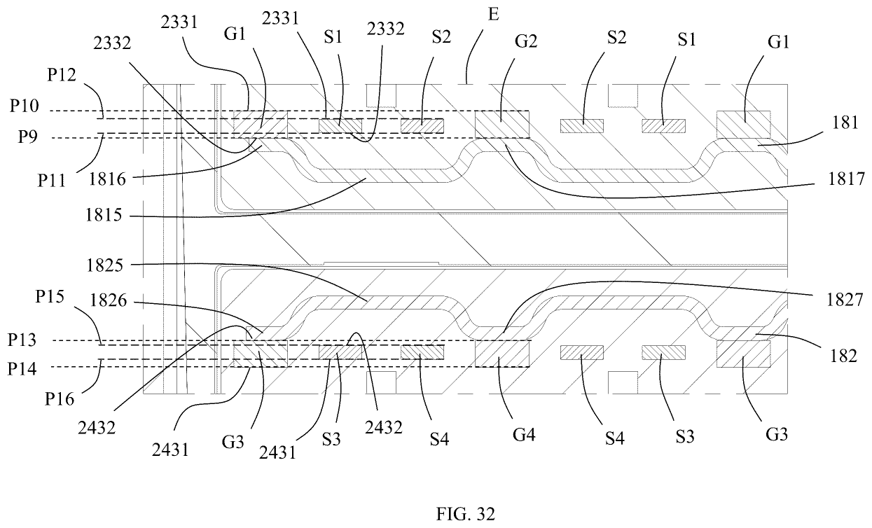

Similarly, referring to FIG. 32, regarding the first tail portion 233 of the first ground terminal G1, the first tail portion 233 of the first signal terminal S1, the first tail portion 233 of the second signal terminal S2, and the first tail portion 233 of the second ground terminal G2, the first abutting surface 2332 of the first tail portion 233 of the first ground terminal G1 is flush with the first abutting surface 2332 of the first tail portion 233 of the second ground terminal G2, and lies in a ninth plane P9. The first soldering surface 2331 of the first tail portion 233 of the first ground terminal G1 is flush with the first soldering surface 2331 of the first tail portion 233 of the second ground terminal G2, and lies in a tenth plane P10. The first abutting surface 2332 of the first tail portion 233 of the first signal terminal S1 is flush with the first abutting surface 2332 of the first tail portion 233 of the second signal terminal S2, and lies in an eleventh plane P11. The first soldering surface 2331 of the first tail portion 233 of the first signal terminal S1 is flush with the first soldering surface 2331 of the first tail portion 233 of the second signal terminal S2, and lies in a twelfth plane P12. In the illustrated embodiment of the present disclosure, in the front-rear direction, the ninth plane P9 extends rearward beyond the eleventh plane P11, and the tenth plane P10 extends forward beyond the twelfth plane P12. A distance between the ninth plane P9 and the tenth plane P10 is greater than a distance between the eleventh plane P11 and the twelfth plane P12. With this configuration, the first ground terminal G1 and the second ground terminal G2 can better reduce crosstalk between differential signal pairs and improve signal transmission quality.

The second terminal module M2 includes a second insulating block 173, a plurality of second conductive terminals 24 fixed to the second insulating block 173, a plurality of second cables 52 connected to the second conductive terminals 24, a second shielding plate 182 coupled to the second insulating block 173, and a second insulating fixing block 174 at least partially fixed on the second insulating block 173, the second conductive terminals 24, the second cables 52 and the second shielding plate 182. In the illustrated embodiment of the present disclosure, the second conductive terminals 24 are insert-molded with the second insulating block 173. The second insulating fixing block 174 is secondarily molded onto the second insulating block 173, the second conductive terminals 24, the second cables 52 and the second shielding plate 182 to form the second terminal module M2 as an integrated unit. In other embodiments of the present disclosure, the second insulating block 173 and the second insulating fixing block 174 may also be integrally formed, meaning the second insulating block 173 and the second insulating fixing block 174 are a single component, collectively referred to as a second insulating molding block 176. Of course, it is understandable to those skilled in the art that in other embodiments, the second conductive terminals 24 may also be fixed to the second insulating block 173 by assembly.

The plurality of second conductive terminals 24 include a third ground terminal G3, a fourth ground terminal G4, a third signal terminal S3, and a fourth signal terminal S4. The third signal terminal S3 and the fourth signal terminal S4 form a second differential pair to enhance the speed of signal transmission. The third ground terminal G3 and the fourth ground terminal G4 are located on two sides (for example, left and right sides) of the second differential pair, respectively, to improve grounding shielding and enhance the quality of signal transmission.

In the illustrated embodiment of the present disclosure, each second conductive terminal 24 includes a second fixing portion 241 fixed in the second insulating block 173, a second contact portion 242 extending from one end of the second fixing portion 241, and a second tail portion 243 extending from another end of the second fixing portion 241. The second contact portion 242 includes a second contact surface 2421 exposed from the second insulating block 173 and a second back surface 2422 disposed opposite to the second contact surface 2421. In the illustrated embodiment of the present disclosure, the second fixing portion 241 is inclined such that the second contact portion 242 and the second tail portion 243 lie in different planes. The second tail portion 243 includes a second soldering surface 2431 and a second abutting surface 2432 disposed opposite to the second soldering surface 2431.

In one embodiment of the present disclosure, the second conductive terminals 24 further include a second connecting rod 244 that connects a distal end of the second contact portion 242 of the third ground terminal G3 to a distal end of the second contact portion 242 of the fourth ground terminal G4, to achieve better signal integrity and improve ground shielding effectiveness. In the illustrated embodiment of the present disclosure, the second connecting rod 244 is embedded in the second insulating block 173 after the insert-molding process.

In one embodiment of the present disclosure, the third ground terminal G3 and the fourth ground terminal G4 are stamped from a third material strip. The third signal terminal S3 and the fourth signal terminal S4 are stamped from a fourth material strip. A thickness of the third material strip is greater than that of the fourth material strip to further enhance the ground shielding effect. The second cable 52 includes a third core 521, a fourth core 522, a third insulating layer 523 wrapping around the third core 521, a fourth insulating layer 524 wrapping around the fourth core 522, a third ground wire 525 located outside the third insulating layer 523, a fourth ground wire 526 located outside the fourth insulating layer 524, a second shielding layer 528 located outside the third insulating layer 523 and the fourth insulating layer 524, and a second insulating sheath 527 wrapping around the outermost layer. As shown in FIG. 3, in the illustrated embodiment of the present disclosure, the second cable 52 extends from the body 1 in a direction opposite to the mating direction B, meaning that a portion of the second cable 52 just protruding out of the body 1 extends in the direction opposite to the mating direction B. It is understandable to those skilled in the art that a length of the second cable 52 may vary depending on the application, and the second cable 52 may experience local deviations, bends, etc., along its entire length. However, this does not affect the description in the present disclosure that the portion of the second cable 52 just protruding out of the body 1 extends in the direction opposite to the mating direction B. This arrangement minimizes a space occupied by the electrical connector 100 in the front-rear direction and the left-right direction, thereby facilitating installation and layout.

In the illustrated embodiment of the present disclosure, the third core 521 and the fourth core 522 are in contact with (for example, soldered to) the second soldering surfaces 2431 of the third signal terminal S3 and the fourth signal terminal S4, respectively. The third ground wire 525 and the fourth ground wire 526 are in contact with (for example, soldered to) the second soldering surfaces 2431 of the third ground terminal G3 and the fourth ground terminal G4, respectively.

The second shielding plate 182 is a second metal shielding plate, meaning it is made of a metal material. The second shielding plate 182 is generally wavy in shape, including a third base portion 1821, a fifth abutting portion 1822 bent from one side of the third base portion 1821, a sixth abutting portion 1823 bent from another side of the third base portion 1821, a second extension portion 1824 connected to the third base portion 1821, a fourth base portion 1825 connected to the second extension portion 1824, a seventh abutting portion 1826 bent from one side of the fourth base portion 1825, an eighth abutting portion 1827 bent from another side of the fourth base portion 1825, and a second end protrusion 1828 connected to the fourth base portion 1825. The second end protrusion 1828, the fourth base portion 1825, the second extension portion 1824, and the third base portion 1821 are connected in sequence along the mating direction B. In the illustrated embodiment of the present disclosure, an overall length of the third base portion 1821, the second extension portion 1824, and the fourth base portion 1825 along the mating direction B is comparable to an overall length of the second contact portion 242, the second fixing portion 241, and the second tail portion 243 of the second conductive terminal 24. With this configuration, the second shielding plate 182 is able to cover the length of the second conductive terminal 24 as much as possible, thereby improving the ground shielding effect.

In the illustrated embodiment of the present disclosure, the third base portion 1821 does not have any opening along its length in the mating direction B, thereby providing superior shielding effectiveness. The fourth base portion 1825 defines a second through hole 1825a in which at least parts of the second tail portions 243 of the third signal terminal S3 and the fourth signal terminal S4 are exposed. This arrangement facilitates soldering on one hand, and allows the second insulating fixing block 174 to fill the second through hole 1825a during secondary molding on the other hand, thereby enhancing the reliability of the connections between the third core 521 and the second tail portion 243 of the third signal terminal S3, as well as between the fourth core 522 and the second tail portion 243 of the fourth signal terminal S4. The second end protrusion 1828 extends upwardly beyond the second tail portions 243 of the second conductive terminals 24, and defines a second solder accommodating hole 1828a. The second shielding layer 528 is exposed in the second solder accommodating hole 1828a, meaning it is visible from the outside when looking into the second solder accommodating hole 1828a. This configuration facilitates filling the second solder accommodating hole 1828a with a solder to securely solder the second shielding layer 528 to the second end protrusion 1828, and also allows the second insulating fixing block 174 to fill the second solder accommodating hole 1828a during secondary molding, thereby improving structural strength.

The number of the fifth abutting portion 1822 is one or more, and the number of the sixth abutting portion 1823 is one or more. In the illustrated embodiment of the present disclosure, two fifth abutting portions 1822 and two sixth abutting portions 1823 are provided to achieve multi-point contact.

Specifically, the fifth abutting portion 1822 is in contact with the second back surface 2422 of the second contact portion 242 of the third ground terminal G3. The sixth abutting portion 1823 is in contact with the second back surface 2422 of the second contact portion 242 of the fourth ground terminal G4. The seventh abutting portion 1826 is in contact with the second abutting surface 2432 of the second tail portion 243 of the third ground terminal G3. The eighth abutting portion 1827 is in contact with the second abutting surface 2432 of the second tail portion 243 of the fourth ground terminal G4. With this configuration, by bringing the second shielding plate 182 into contact with the third ground terminal G3 and the fourth ground terminal G4, the ground shielding effect is improved. Of course, it is understandable to those skilled in the art that the third signal terminal S3 and the fourth signal terminal S4 are not in contact with the second shielding plate 182 under any circumstances to prevent short circuits.

In one embodiment of the present disclosure, the fifth abutting portion 1822 is fixed to the second back surface 2422 of the second contact portion 242 of the third ground terminal G3 by soldering. The sixth abutting portion 1823 is fixed to the second back surface 2422 of the second contact portion 242 of the fourth ground terminal G4 by soldering. The seventh abutting portion 1826 is fixed to the second abutting surface 2432 of the second tail portion 243 of the third ground terminal G3 by soldering. The eighth abutting portion 1827 is fixed to the second abutting surface 2432 of the second tail portion 243 of the fourth ground terminal G4 by soldering.

During manufacturing, in one embodiment of the present disclosure, the third ground terminal G3 and the fourth ground terminal G4 are connected to the third carrier strip portion 245. The third signal terminal S3 and the fourth signal terminal S4 are connected to the fourth carrier strip portion 246. Then, the third carrier strip portion 245 and the fourth carrier strip portion 246 are stacked together, with the third ground terminal G3, the third signal terminal S3, the fourth signal terminal S4, and the fourth ground terminal G4 arranged sequentially along the left-right direction, ensuring the relative positions among the terminals meet the design requirements. Subsequently, the second insulating block 173 is injection-molded onto the second conductive terminal 24. Then, the third conductor 521, the fourth conductor 522, the third ground wire 525, and the fourth ground wire 526 of the second cable 52 are soldered to the second soldering surface 2431 of the third signal terminal S3, the second soldering surface 2431 of the fourth signal terminal S4, the second soldering surface 2431 of the third ground terminal G3, and the second soldering surface 2431 of the fourth ground terminal G4, respectively. Finally, the second insulating fixing block 174 is secondarily molded onto the second insulating block 173, the second conductive terminal 24, the second cable 52 and the second shielding plate 182, integrating the second terminal module M2 into a single unit.

Referring to FIG. 33, in the illustrated embodiment of the present disclosure, regarding the second contact portion 242 of the third ground terminal G3, the second contact portion 242 of the third signal terminal S3, the second contact portion 242 of the fourth signal terminal S4, and the second contact portion 242 of the fourth ground terminal G4, the second back surface 2422 of the second contact portion 242 of the third ground terminal G3 is flush with the second back surface 2422 of the second contact portion 242 of the fourth ground terminal G4, and lies in a fifth plane P5. The second contact surface 2421 of the second contact portion 242 of the third ground terminal G3 is flush with the second contact surface 2421 of the second contact portion 242 of the fourth ground terminal G4, and lies in a sixth plane P6. The second back surface 2422 of the second contact portion 242 of the third signal terminal S3 is flush with the second back surface 2422 of the second contact portion 242 of the fourth signal terminal S4, and lies in a seventh plane P7. The second contact surface 2421 of the second contact portion 242 of the third signal terminal S3 is flush with the second contact surface 2421 of the second contact portion 242 of the fourth signal terminal S4, and lies in an eighth plane P8. In the illustrated embodiment of the present disclosure, in the front-rear direction, the fifth plane P5 extends forward beyond the seventh plane P7, and the sixth plane P6 extends rearward beyond the eighth plane P8. A distance between the fifth plane P5 and the sixth plane P6 is greater than a distance between the seventh plane P7 and the eighth plane P8. With this configuration, the third ground terminal G3 and the fourth ground terminal G4 can more effectively reduce crosstalk between differential signal pairs and improve signal transmission quality.

Specifically, in one embodiment of the present disclosure, a distance between the fifth plane P5 and the seventh plane P7 is greater than 0, and less than or equal to half a distance between the second contact surface 2421 of the second contact portion 242 of the third signal terminal S3 and the second back surface 2422 of the second contact portion 242 of the third signal terminal S3 (i.e., a thickness of the second contact portion 242 of the third signal terminal S3). Similarly, a distance between the sixth plane P6 and the eighth plane P8 is greater than 0, and less than or equal to half the distance between the second contact surface 2421 of the second contact portion 242 of the third signal terminal S3 and the second back surface 2422 of the second contact portion 242 of the third signal terminal S3 (i.e., the thickness of the second contact portion 242 of the third signal terminal S3). In one embodiment of the present disclosure, a distance value between the sixth plane P6 and the seventh plane P7 divided by a distance value between the seventh plane P7 and the eighth plane P8 is R4, where 1.2≤R4≤1.4. A distance value between the fifth plane P5 and the eighth plane P8 divided by the distance value between the seventh plane P7 and the eighth plane P8 is R5, where 1.2≤R5≤1.4. A distance value between the fifth plane P5 and the sixth plane P6 divided by a distance value between the seventh plane P7 and the eighth plane P8 is R 6, where 1.4≤R6≤1.6. In one embodiment of the present disclosure, R4=1.3, R5=1.3, and R6=1.5.

Of course, in other embodiments of the present disclosure, the fifth plane P5 may also be flush with the seventh plane P7, meaning that the fifth plane P5 and the seventh plane P7 are the same plane. Similarly, the sixth plane P6 may also be flush with the eighth plane P8, meaning that the sixth plane P6 and the eighth plane P8 are the same plane.

Similarly, referring to FIG. 32, regarding the second tail portion 243 of the third ground terminal G3, the second tail portion 243 of the third signal terminal S3, the second tail portion 243 of the fourth signal terminal S4, and the second tail portion 243 of the fourth ground terminal G4, the second abutting surface 2432 of the second tail portion 243 of the third ground terminal G3 and the second abutting surface 2432 of the fourth ground terminal G4 are flush, and lie in a thirteenth plane P13. The second soldering surface 2431 of the second tail portion 243 of the third ground terminal G3 and the second soldering surface 2431 of the fourth ground terminal G4 are flush, and lie in a fourteenth plane P14. The second abutting surface 2432 of the second tail portion 243 of the third signal terminal S3 and the second abutting surface 2432 of the fourth signal terminal S4 are flush, and lie in a fifteenth plane P15. The second soldering surface 2431 of the second tail portion 243 of the third signal terminal S3 and the second soldering surface 2431 of the fourth signal terminal S4 are flush, and lie in a sixteenth plane P16. In the illustrated embodiment of the present disclosure, in the front-rear direction, the thirteenth plane P13 extends forward beyond the fifteenth plane P15, and the fourteenth plane P14 extends rearward beyond the sixteenth plane P16. A distance between the thirteenth plane P13 and the fourteenth plane P14 is greater than a distance between the fifteenth plane P15 and the sixteenth plane P16. With this configuration, the third ground terminal G3 and the fourth ground terminal G4 can better reduce crosstalk between differential signal pairs and improve signal transmission quality.

In the illustrated embodiment of the present disclosure, referring to FIG. 33, the first terminal module M1 and the second terminal module M2 are symmetrically arranged on two sides of the positioning plate 13. The first shielding plate 181 of the first terminal module M1 and the second shielding plate 182 of the second terminal module M2 are positioned adjacent to each other and approximately in a middle of the body 1. This configuration allows the first shielding plate 181 and the second shielding plate 182 to more effectively prevent crosstalk between signals in the first terminal module M1 and the second terminal module M2.

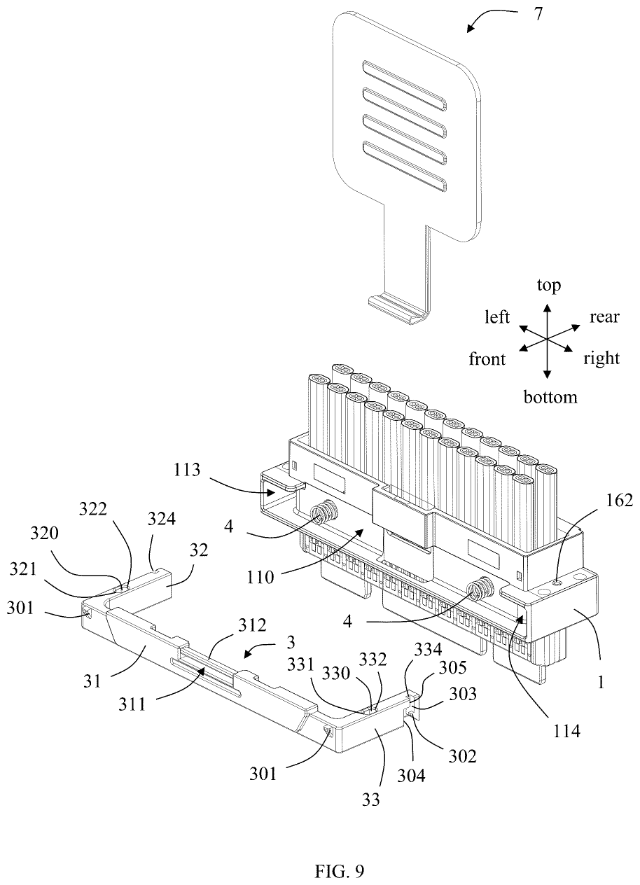

Referring to FIG. 9 to FIG. 12, the movable component 3 is at least partially installed to the main body portion 11. The movable component 3 includes a base 31, a first ejector rod 32 extending backwardly from one side of the base 31, and a second ejector rod 33 extending backwardly from another side of the base 31. The base 31 is accommodated in the receiving space 110. Most of the first ejector rod 32 is accommodated in the first receiving groove 113 except a rear end of the first ejector rod 32 which extends out of the first receiving groove 113. Most of the second ejector rod 33 is accommodated in the second receiving groove 114 except a rear end of the second ejector rod 33 which extends out of the second receiving groove 114. Both the first ejector rod 32 and the second ejector rod 33 can be referred to as ejector rods which extend from the first end wall 111 to the second end wall 112 with the rear ends thereof protruding beyond the second end wall 112.

The base 31 includes two first locking protrusions 301 located on two sides (for example, left and right sides) of the base 31, respectively, so as to improve the mating retention force. The first locking protrusions 301 are integrally formed with the main body portion 11 and extend forwardly beyond the first end wall 111. Of course, in another embodiment, the first locking protrusions 301 and the main body portion 11 can also be manufactured separately, and then assembled and fixed together. In this case, the first locking protrusions 301 can be made of a material, for example, a wear-resistant material with better structural strength, different from that of the main body portion 11. The base 31 further includes a pull strap connecting portion 312 to which the pull strap 7 is connected. The movable component 3 includes a transverse slot 311 extending through the base 31 along the moving direction C. The pull strap connecting portion 312 is located above the transverse slot 311. The pull strap connecting portion 312 is similar to a shaft portion, and is located between the transverse slot 311 and the edge (for example, the upper edge) of the base 31. One end of the pull strap 7 passes through the transverse slot 311 and is sleeved around the pull strap connecting portion 312.

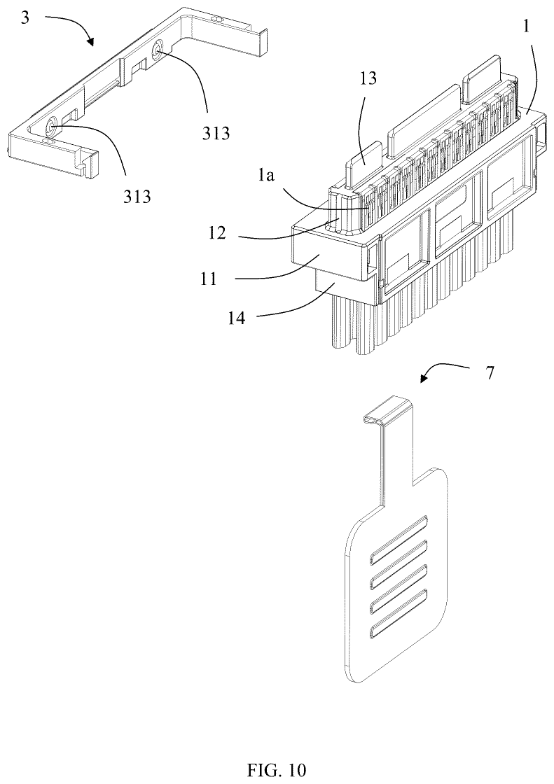

In the illustrated embodiment of the present disclosure, the elastic component 4 is a compression spring installed between the base 31 and the inner wall surface 115 of the main body portion 11. The number of the compression springs is two, and the two compression springs are arranged side by side to improve the stability of the movable component 3 when the movable component 3 is moving. Besides, referring to FIG. 10, in order to better positioning the compression spring, the base 31 is further provided with a positioning post 313 which is at least partially inserted into the compression spring.

The movable component 3 further includes at least one second locking protrusion 302 protruding backwardly beyond the second end wall 112. In the illustrated embodiment of the present disclosure, the number of the second locking protrusions 302 is two. One of the second locking protrusions 302 is located at the rear end of the first ejector rod 32 away from the base 31. The one of the second locking protrusions 302 is located outside the first receiving groove 113 and protrudes toward the first receiving groove 113. A remaining one of the second locking protrusions 302 is located at the rear end of the second ejector rod 33 away from the base 31. The remaining one of the second locking protrusions 302 is located outside the second receiving groove 114 and protrudes toward the second receiving groove 114. The two second locking protrusions 302 are arranged in such a manner to improve an engagement force. The second locking protrusion 302 is integrally formed with a corresponding ejector rod to save cost. Of course, in another embodiment, the second locking protrusion 302 and the corresponding ejector rod can also be produced separately, and then assembled and fixed together. In this case, the second locking protrusion 302 can be made of a different material from that of the corresponding ejector rod. The first locking protrusions 301 and the second locking protrusions 302 are to lock with locking holes of the mating connector 200 to improve the mating retention force.

The first ejector rod 32 includes a first limiting groove 320 located in the middle, a first limiting surface 321 located at one end of the first limiting groove 320 along the moving direction C, and a second limiting surface 322 is located at another end of the first limiting groove 320 along the moving direction C. Compared with the second limiting surface 322, the first limiting surface 321 is closer to the first end wall 111.

Similarly, the second ejector rod 33 includes a second limiting groove 330 located in the middle, a third limiting surface 331 located at one end of the second limiting groove 330 along the moving direction C, and a fourth limiting surface 332 is located at another end of the second limiting groove 330 along the moving direction C. Compared with the fourth limiting surface 332, the third limiting surface 331 is closer to the first end wall 111.

The first ejector rod 32 further includes a first concave groove 324 located at a distal end (for example, a rear end) thereof, and the second ejector rod 33 further includes a second concave groove 334 located at a distal end (for example, a rear end) thereof. Both the first concave groove 324 and the second concave groove 334 are referred to as groove portions. Each groove portion has a first blocking wall 303 (for example, a rear blocking wall), a second blocking wall 304 (for example, a front lower blocking wall) and a third blocking wall 305 (for example, a front upper blocking wall). The second blocking wall 304 is located below the first blocking wall 303 to face the first blocking wall 303. The third blocking wall 305 is located above the first blocking wall 303 to face the first blocking wall 303. A large-diameter portion (not numbered) is formed between the first blocking wall 303 and the second blocking wall 304, and a small-diameter portion (not numbered) is formed between the first blocking wall 303 and the third blocking wall 305. A dimension of the small-diameter portion in the front-rear direction is smaller than a dimension of the large-diameter portion in the front-rear direction.

It should be noted that: in this embodiment, the groove portion extends vertically, and includes the small-diameter portion and the large-diameter portion. The small-diameter portion exists according to the manufacturing process of the groove portion. In another embodiment, the groove portion does not include the small-diameter portion and only includes the large-diameter portion, so that when the insertion plate portion 8321 is accommodated in the groove portion which only includes the large-diameter portion, the groove portion can move together with the movable component 3 in the front-rear direction, and the second locking protrusion 302 can be inserted into the second locking hole 8322 of the insertion plate portion 8321 for engagement.

The second locking protrusion 302 protrudes from the bottom of the first blocking wall 303 toward the second blocking wall 304. The second locking protrusion 302 is spaced from the second blocking wall 304 by a distance. Because the first locking protrusion 301 also protrudes from the rear to the front, the first locking protrusion 301 and the second locking protrusion 302 in the present disclosure have the same forward protruding direction. The forward protruding direction is opposite to the moving direction C.

The electrical connector 100 includes a first pin 151 fixed in the first mounting hole 1161 and a second pin 152 fixed in the second mounting hole 1162. The first pin 151 is inserted into the first limiting groove 320 and the second pin 152 is inserted into the second limiting groove 330. A dimension of the first limiting groove 320 is larger than a dimension of the first pin 151 along the moving direction C. A dimension of the second limiting groove 330 is larger than a dimension of the second pin 152 along the moving direction C. The first limiting surface 321 is used for engaging with the first pin 151, and the third limiting surface 331 is used for engaging with the second pin 152, so as to prevent the movable component 3 from moving excessively along the moving direction C. The second limiting surface 322 is used for engaging with the first pin 151, and the fourth limiting surface 332 is used for engaging with the second pin 152, so as to prevent the movable component 3 from returning excessively along an opposite direction of the moving direction C.

After the first terminal module M1 and the second terminal module M2 are inserted into the first mounting groove 141 and the second mounting groove 142, respectively, the first insulating block 171 passes through the main body portion 11 and is located on one side of the positioning plate 13, while the second insulating block 173 passes through the main body portion 11 and is located on another side of the positioning plate 13. The first contact surface 2321 of the first conductive terminal 23 is exposed on one side of the body 1, and the second contact surface 2421 of the second conductive terminal 24 is exposed on another side of the body 1. The first insulating block 171, the first contact portion 232 of the first conductive terminal 23, the extension plate 12, the second insulating block 173 and the second contact portion 242 of the second conductive terminal 24 together form a tongue plate 1a for being inserted into the mating connector 200. The first contact surface 2321 of the first conductive terminal 23 and the second contact surface 2421 of the second conductive terminal 24 are respectively exposed on opposing surfaces of the tongue plate 1a. Since the extension plate 12 is made of the metal material, it can effectively isolate the first conductive terminals 23 and the second conductive terminals 24 located on its two sides, which helps improve the quality of signal transmission.

When the first terminal module M1 and the second terminal module M2 are installed in place, the first stop bar 1481 and the second stop bar 1482 are inserted along a direction in which the first terminal module M1 and the second terminal module M2 are arranged side by side (for example, the front-rear direction) into the first positioning hole 1471 and the second positioning hole 1472, respectively. The first stop bar 1481 and the second stop bar 1482 abut against the first insulating fixing block 172 and the second insulating fixing block 174 to prevent the first terminal module M1 and the second terminal module M2 from detaching from the body 1. In the illustrated embodiment of the present disclosure, after the first stop bar 1481 and the second stop bar 1482 are installed, the limiting block 6 is then formed in the mounting space 140. On one hand, the limiting block 6 combines the first terminal module M1 and the second terminal module M2 into a single unit; and on the other hand, the limiting block 6 is fixed to the body 1. For example, the limiting block 6 is secured in the first perforations 1430 and the second perforations 1440.

Of course, it is understandable to those skilled in the art that in other embodiments of the present disclosure, the limiting block 6 may first be fixed together with the first terminal module M1 and the second terminal module M2 as an integrated unit, and then the entire assembly may be installed to the body 1.

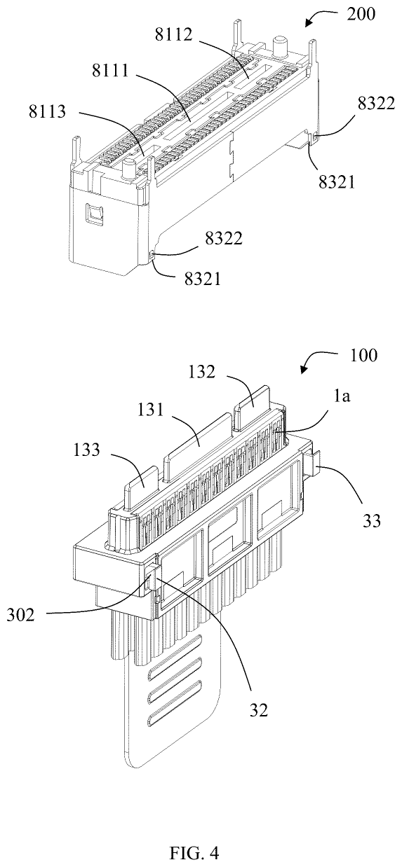

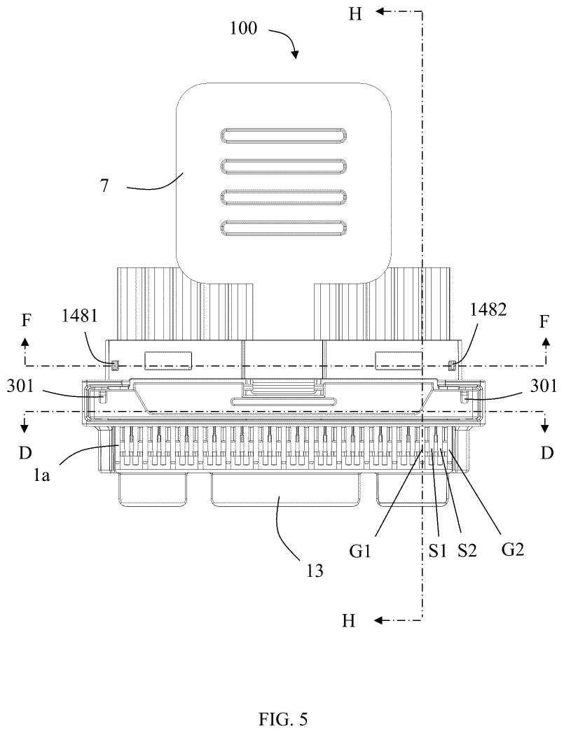

Referring to FIG. to FIG. 4 and FIG. 7 to FIG. 12, the mating connector 200 includes a mating insulating body 81, a plurality of mating terminals 82 fixed to the mating insulating body 81, and a metal shell 83 enclosing the mating insulating body 81. The mating insulating body 81 includes a bottom wall 811 and a plurality of wall portions 812 perpendicular to the bottom wall 811. Referring to FIG. 5, the plurality of wall portions 812 include a first wall portion 8121, a second wall portion 8122 disposed opposite to the first wall portion 8121, a first connecting wall portion 8123 connecting one side of the first wall portion 8121 and one side of the second wall portion 8122, and a second connecting wall portion 8124 connecting another side of the first wall portion 8121 and another side of the second wall portion 8122. The bottom wall 811 defines a positioning groove 8110 for accommodating the positioning plate 13. Specifically, the positioning groove 8110 includes a first positioning groove 8111 for accommodating the first positioning piece 131, a second positioning groove 8112 for accommodating the second positioning piece 132, and a third positioning groove 8113 for accommodating the third positioning piece 133. The first positioning groove 8111, the second positioning groove 8112 and the third positioning groove 8113 all extend through the bottom wall 811.

The mating connector 200 includes a terminal fixing block 84 to which the mating terminals 82 are fixed. The mating insulating body 81 includes a terminal accommodating groove 813 in which the terminal fixing block 84 is fixed. The terminal fixing block 84 includes a first engaging portion 841. A second engaging portion 8131 is provided on one side of the terminal accommodating groove 813. The first engaging portion 841 and the second engaging portion 8131 are engaged with each other, so that the terminal fixing block 84 is fixed in the terminal accommodating groove 813. In the illustrated embodiment of the present disclosure, the first engaging portion 841 is a dovetail-shaped bump and the second engaging portion 8131 is a dovetail-shaped groove matching the dovetail-shaped bump.

In some embodiments, the number of the terminal fixing blocks 84 is two, and the two terminal fixing blocks 84 are symmetrical and spaced apart from each other. The mating terminals 82 are arranged in two symmetrical rows and the two rows of mating terminals 82 are fixed to the two terminal fixing blocks 84, respectively. Two terminal accommodating grooves 813 are provided, and the two terminal accommodating grooves 813 are symmetrical and spaced apart from each other. The two terminal accommodating grooves 813 are respectively formed between the bottom wall 811 and the two opposite wall portions 812. The two terminal fixing blocks 84 are fixed in the two terminal accommodating grooves 813. Each of the terminal fixing blocks 84 includes a plurality of first engaging portions 841. One side of each of the terminal accommodating grooves 813 includes a plurality of second engaging portions 8131 corresponding to the plurality of first engaging portions 841 respectively. Each of the first engaging portions 841 and the corresponding second engaging portions 8131 are engaged with each other, so that each terminal fixing block 84 is fixed in the corresponding terminal accommodating groove 813. The first engaging portions 841 are respectively disposed on the sides of the two terminal fixing blocks 84 facing each other. The second engaging portions 8131 are respectively disposed on opposite sides of the bottom wall 811 facing the two terminal accommodating grooves 813.

The wall portions 812 are enclosed to form a mating slot 8120 for receiving the tongue plate 1a. The mating terminals 82 are arranged in two rows. Each mating terminal 82 includes an elastic mating arm 821 and a mounting tail 822. The mounting tail 822 is used for being mounted on a circuit board. The elastic mating arm 821 extends into the mating slot 8120 for being in contact with the mating portion 21.

The metal shell 83 includes a first side wall 831, a second side wall 832, a first connecting wall 833, and a second connecting wall 834. The second side wall 832 is disposed opposite to the first side wall 831. The first connecting wall 833 connects one side of the first side wall 831 and one side of the second side wall 832. The second connecting wall 834 connects another side of the first side wall 831 and another side of the second side wall 832. The first side wall 831 defines a first locking hole 8311 engaged with the first locking protrusion 301. The second side wall 832 includes two insertion plate portion 8321 at a corner adjacent to the first connecting wall 833 and at a corner adjacent to the second connecting wall 834. That is to say, each of the left and right sides of the second side wall 832 includes one insertion plate portion 8321. The insertion plate portion 8321 defines a second locking hole 8322 matched with the second locking protrusion 302. The insertion plate portion 8321 is integrally formed on the second side wall 832. The insertion plate portion 8321 and the first connecting wall 833 are integrally formed, and the insertion plate portion 8321 and the second connecting wall 834 are also integrally formed without any gap. Therefore, the insertion plate portion 8321 has no elasticity.

When the electrical connector 100 is inserted into the mating connector 200, the positioning plate 13 is correspondingly accommodated in the positioning groove 8110, the tongue plate 1a is correspondingly accommodated in the mating slot 8120, and the first contact surface 2321 of the first conductive terminal 23 and the second contact surface 2421 of the second conductive terminal 24 are configured to be in contact with corresponding elastic mating arms 821 of the mating terminals 82. With the insertion of the electrical connector 100, the inclined surface of the first locking protrusion 301 abuts against the first side wall 831, and the inclined surface of the second locking protrusion 302 abuts against the second side wall 832. The movable component 3 overcomes the force of the elastic component 4, and shrinks inward by a certain distance along the moving direction C. When the first locking protrusion 301 moves downwardly to the first locking hole 8311, and the second locking protrusion 302 moves downwardly to the second locking hole 8322, the elastic force of the elastic component 4 is released, so that the movable component 3 moves backwardly in the direction opposite to the moving direction C. The first locking protrusion 301 protrudes forwardly into the first locking hole 8311, and the second locking protrusion 302 protrudes forwardly and protrudes into the second locking hole 8322, thereby realizing the locking of the electrical connector 100 and the mating connector 200.

In the present disclosure, by providing the first locking protrusion 301 and the second locking protrusion 302 on two sides, two-side locking in the front-rear direction/the second direction can be achieved, thereby improving the mating reliability, and reducing the risk of the electrical connector 100 and the mating connector 200 becoming loose or tilted.

When the electrical connector 100 and the mating connector 200 need to be unlocked, an external force is applied to pull the pull strap 7, and the pull strap 7 generates a component force along the moving direction C, and the component force in this direction overcomes the force of the elastic component 4, so that the movable component 3 moves along the moving direction C. The first ejector rod 32 and the second ejector rod 33 move away from the insertion plate portion 8321 backwards, so that the second locking protrusion 302 and the second locking hole 8322 are disengaged from each other. The first locking protrusion 301 and the first locking hole 8311 are also separated from each other. In other words, the electrical connector 100 and the mating connector 200 are unlocked on two sides. As a result, the electrical connector 100 can be pulled out of the mating connector 200 by applying another force or by an upward component force exerted on the pull strap 7.

The insertion plate portion 8321 is accommodated in the large-diameter portion of the groove portion in both the locked state of the electrical connector 100 and the mating connector 200, and the unlocked state of the electrical connector 100 and the mating connector 200. When the movable component 3 drives the second locking protrusion 302 to move, and the second locking protrusion 302 cooperates with the second locking hole 8322, the insertion plate portion 8321 is in contact with the first blocking wall 303, and the insertion plate portion 8321 is separated from the second blocking wall 304. When the movable component 3 drives the second locking protrusion 302 to move, and the second locking protrusion 302 and the second locking hole 8322 are disengaged from each other, the insertion plate portion 8321 is in contact with the second blocking wall 304, and the insertion plate portion 8321 is separated from the first blocking wall 303.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
a body, the body defining a first receiving groove and a second receiving groove;
a first terminal module, the first terminal module being at least partially disposed in the body, the first terminal module comprising a plurality of first conductive terminals and a first cable electrically connected to the first conductive terminals; and
a movable component, the movable component being mounted to the body and being movable relative to the body along a moving direction; the movable component comprising a base portion, a first push rod and a second push rod; the base portion being provided with a plurality of first locking protrusions; a portion of the first push rod being received in the first receiving groove, and one end of the first push rod extending out of the first receiving groove; a portion of the second push rod being received in the second receiving groove, and one end of the second push rod extending out of the second receiving groove; each of the one end of the first push rod and the one end of the second push rod being both provided with a second locking protrusion; the first locking protrusions and the second locking protrusions being configured to lock with a mating connector;
wherein the first cable extends beyond the body, and the first cable extends from the body in a direction opposite to the mating direction.

2. The electrical connector according to claim 1, wherein the body comprises a main body portion; the main body portion comprises a first end wall and a second end wall opposite to the first end wall; the first locking protrusions protrude from the first end wall toward one side, and the second locking protrusions protrude from the second end wall toward another side.

3. The electrical connector according to claim 2, wherein the body defines a receiving space extending through the first end wall; the first receiving groove and the second receiving groove are located on two sides of the body, respectively, and are both in communication with the receiving space.

4. The electrical connector according to claim 3, wherein the base portion is received in the receiving space, the first push rod extends from one side of the base portion, and the second push rod extends from another side of the base portion.

5. The electrical connector according to claim 4, wherein the base portion is provided with an inner wall surface exposed in the receiving space;
the electrical connector further comprises an elastic component disposed between the base portion and the inner wall surface.

6. The electrical connector according to claim 5, wherein the elastic component is a compression spring, and two compression springs are provided and arranged side by side.

7. The electrical connector according to claim 1, wherein the first locking protrusions and the second locking protrusions have a same protruding direction, and the protruding direction is opposite to the moving direction.

8. The electrical connector according to claim 1, wherein the body is a metal body.

9. The electrical connector according to claim 1, wherein the body defines a first mounting groove;
the first terminal module is at least partially disposed in the first mounting groove; the plurality of first conductive terminals comprise a first ground terminal, a first signal terminal, a second signal terminal, and a second ground terminal; the first signal terminal and the second signal terminal are both located between the first ground terminal and the second ground terminal; each first conductive terminal comprises a first contact portion, and the first contact portion comprises a first contact surface and a first back surface opposite to the first contact surface;
the first conductive terminals further comprise a first connecting rod connecting a distal end of the first contact portion of the first ground terminal and a distal end of the first contact portion of the second ground terminal.

10. The electrical connector according to claim 9, wherein the first cable comprises a first core, a second core, a first insulating layer wrapping around the first core, a second insulating layer wrapping around the second core, a first ground wire located outside the first insulating layer, and a second ground wire located outside the second insulating layer; wherein the first core is electrically connected to the first signal terminal; the second core is electrically connected to the second signal terminal; the first ground wire is electrically connected to the first ground terminal; and the second ground wire is electrically connected to the second ground terminal.

11. The electrical connector according to claim 9, wherein the first terminal module comprises a first insulating block fixed to the first conductive terminals, and the first contact surface of the first conductive terminal is exposed from the first insulating block.

12. The electrical connector according to claim 11, wherein the first conductive terminals are insert-molded with the first insulating block, and the first connecting rod is embedded in the first insulating block.

13. The electrical connector according to claim 11, wherein the first terminal module comprises a first shielding plate coupled to the first insulating block and cooperating with the first conductive terminals; the first shielding plate comprises a first base portion, a first abutting portion bent from one side of the first base portion, and a second abutting portion bent from another side of the first base portion; the first abutting portion is in contact with the first back surface of the first contact portion of the first ground terminal, and the second abutting portion is in contact with the first back surface of the first contact portion of the second ground terminal.

14. The electrical connector according to claim 1, wherein the body defines a second mounting groove;
the electrical connector further comprises a second terminal module at least partially disposed in the second mounting groove; the second terminal module comprises a plurality of second conductive terminals, the plurality of second conductive terminals comprise a third ground terminal, a third signal terminal, a fourth signal terminal, and a fourth ground terminal, the third signal terminal and the fourth signal terminal are both located between the third ground terminal and the fourth ground terminal; each second conductive terminal comprises a second contact portion, and the second contact portion comprises a second contact surface and a second back surface opposite to the second contact surface;
wherein the second conductive terminals further comprise a second connecting rod connecting a distal end of the second contact portion of the third ground terminal and a distal end of the second contact portion of the fourth ground terminal.

15. The electrical connector according to claim 14, wherein the second terminal module comprises a second insulating block fixed to the second conductive terminals, and the second contact surface of the second conductive terminal is exposed from the second insulating block.

16. The electrical connector according to claim 15, wherein the second conductive terminals are insert-molded with the second insulating block, and the second connecting rod is embedded in the second insulating block.

17. The electrical connector according to claim 15, wherein the second terminal module comprises a second shielding plate coupled to the second insulating block and cooperating with the second conductive terminals; the second shielding plate comprises a third base portion, a fifth abutting portion bent from one side of the third base portion, and a sixth abutting portion bent from another side of the third base portion; the fifth abutting portion is in contact with the second back surface of the second contact portion of the third ground terminal, and the sixth abutting portion is in contact with the second back surface of the second contact portion of the fourth ground terminal.

18. The electrical connector according to claim 14, wherein the second terminal module comprises a second cable electrically connected to the second conductive terminals;
wherein the second cable extends beyond the body, and the second cable extends from the body in a direction opposite to the mating direction.

19. A connector assembly, comprising:
an electrical connector, the electrical connector comprising:
a body, the body defining a first receiving groove and a second receiving groove;
a first terminal module, the first terminal module being at least partially disposed in the body, the first terminal module comprising a plurality of first conductive terminals and a first cable electrically connected to the first conductive terminals; and
a movable component, the movable component being mounted to the body and being movable relative to the body along a moving direction; the movable component comprising a base portion, a first push rod and a second push rod; the base portion being provided with a plurality of first locking protrusions; a portion of the first push rod being received in the first receiving groove, and one end of the first push rod extending out of the first receiving groove; a portion of the second push rod being received in the second receiving groove, and one end of the second push rod extending out of the second receiving groove; each of the one end of the first push rod and the one end of the second push rod being both provided with a second locking protrusion; the first locking protrusions and the second locking protrusions being configured to lock with a mating connector;
wherein the first cable extends beyond the body, and the first cable extends from the body in a direction opposite to the mating direction; and
a mating connector, the mating connector comprising:
a mating insulating body, the mating insulating body comprising a plurality of wall portions and a mating slot defined by the plurality of wall portions; the plurality of wall portions comprising a first wall portion, a second wall portion disposed opposite to the first wall portion, a first connecting wall portion connecting one side of the first wall portion and one side of the second wall portion, and a second connecting wall portion connecting another side of the first wall portion and another side of the second wall portion; the mating slot being configured to at least partially receive the electrical connector along a mating direction;
a plurality of mating terminals, the mating terminals being at least partially disposed in the mating insulating body; each mating terminal comprising an elastic mating arm extending into the mating slot and configured to be in contact with the first contact surface of the first conductive terminal of the electrical connector; and
a metal shell, the metal shell at least partially covering the mating insulating body; the metal shell comprising a first side wall, a second side wall disposed opposite to the first side wall, a first connecting wall connecting one side of the first side wall and one side of the second side wall, and a second connecting wall connecting another side of the first side wall and another side of the second side wall.

20. The connector assembly according to claim 19, wherein the body defines a first mounting groove;
the first terminal module is at least partially disposed in the first mounting groove; the plurality of first conductive terminals comprise a first ground terminal, a first signal terminal, a second signal terminal, and a second ground terminal; the first signal terminal and the second signal terminal are both located between the first ground terminal and the second ground terminal; each first conductive terminal comprises a first contact portion, and the first contact portion comprises a first contact surface and a first back surface opposite to the first contact surface;
the first conductive terminals further comprise a first connecting rod connecting a distal end of the first contact portion of the first ground terminal and a distal end of the first contact portion of the second ground terminal.
